(19) United States
(12) Patent Application Publication
(10) Pub. No.: US 2017/0120892 A1
(43) Pub. Date: May 4, 2017

(54) VEHICLE CONTROL APPARATUS

(71) Applicant: TOYOTA JIDOSHA KABUSHIKI KAISHA, Toyota-shi (JP)

(72) Inventors: Mitsuharu KATO, Kasugai-shi (JP); Haruki OGURI, Toyota-shi (JP)

(73) Assignee: TOYOTA JIDOSHA KABUSHIKI KAISHA, Toyota-shi (JP)

(21) Appl. No.: 15/286,103

(22) Filed: Oct. 5, 2016

(30) Foreign Application Priority Data
Oct. 30, 2015 (JP) 2015-213667

(51) Int. Cl. B60W 20/14; B60W 10/184; B60W 50/14; B60W 10/04; B60L 7/18; B60W 20/40; B60W 30/18

(52) U.S. Cl. CPC B60W 20/14; B60W 20/40; B60W 10/184; B60W 30/18127; B60W 10/04; B60L 7/18; B60W 50/14; B60Y 2300/91; B60Y 2300/43; B60Y 2300/60; B60Y 2400/112; B60Y 2300/18125; Y10S 903/947; B60W 2510/244

(57) ABSTRACT

A vehicle control apparatus of the invention is applied to a hybrid vehicle. The apparatus executes an enlarged regeneration control for applying an increased regeneration braking force larger than a normal regeneration braking force to at least one vehicle wheel when a position where it is predicted that a deceleration of the hybrid vehicle ends is set as a target deceleration end position and the acceleration operation amount is zero. The apparatus executes a downslope prediction control when determining that a downslope zone exists on a scheduled traveling route of the hybrid vehicle in order to decrease a battery charge amount. The apparatus forbids an execution of the enlarged regeneration control when both a condition for executing the downslope prediction control and a condition for executing the enlarged regeneration control are satisfied.

### BACKGROUND OF THE INVENTION

Field of the Invention

The present invention relates to a vehicle control apparatus applied to a hybrid vehicle, which can efficiently perform regeneration braking to increase an amount of electricity or electric energy recovered to a rechargeable battery

Description of the Related Art

Conventionally, there is known a control apparatus of a hybrid vehicle which predicts a stop position where a driver of the hybrid vehicle stops the hybrid vehicle on a scheduled traveling route as a target stop position on the basis of route information acquired from a navigation device (see JP 2014-110677 A). This control apparatus performs an informing for prompting the driver to release an acceleration pedal of the hybrid vehicle when the hybrid vehicle arrives at a first position before the target stop position. Then, the control apparatus increases regeneration braking force generated upon release of the acceleration pedal, compared with a normal regeneration braking force generated upon release of the acceleration pedal while the acceleration pedal is released after the hybrid vehicle arrives at a second position after the first position and before the target stop position. According to this control apparatus, an amount of thermal energy consumed in braking by a friction braking device can be decreased. Thus, an increased amount of the electric energy (i.e., regeneration electricity) can be recovered to the rechargeable battery. As a result, fuel consumption of the hybrid vehicle can be decreased. The above-mentioned control is called as “an enlarged regeneration control”.

When the hybrid vehicle travels along a downslope, large braking force is required with a high frequency, compared with the case that the hybrid vehicle travels along a flat road. Therefore, when the hybrid vehicle travels along the downslope, a large amount of the regeneration electricity can be recovered to the rechargeable battery. In this regard, in order to prevent deterioration of the battery, the regeneration braking is limited such that an amount of the electricity charged in the battery (hereinafter, the amount of the electricity charged in the battery will be referred to as “the battery charge amount”) does not exceed a predetermined upper limit value. Therefore, when the battery charge amount is large at a start position of the downslope, the battery charge amount reaches the predetermined upper limit value during the vehicle traveling along the downslope and thus, the regeneration electricity cannot be recovered to the battery any more.

Accordingly, another conventional control apparatus is configured to execute a control for driving the hybrid vehicle by an output of an electric motor without an output of an internal combustion engine in priority to a control for driving the hybrid vehicle by both the outputs of the engine and the motor in order to decrease the battery charge amount before the hybrid vehicle arrives at the start position of the downslope when it is predicted that the downslope exists along a scheduled traveling route (see JP 2005-160269 A).

Thereby, when the hybrid vehicle arrives at the start position of the downslope, the battery charge amount decreases to a small amount and thus, the battery charge amount is unlikely to reach the predetermined upper limit value during the hybrid vehicle traveling along the downslope. As a result, while the hybrid vehicle travels along the downslope, the increased amount of the regeneration electricity can be recovered to the rechargeable battery and thus, the fuel consumption of the hybrid vehicle can be decreased. It should be noted that such a control will be referred to as “the downslope prediction control”.

Inventors of this application are developing the hybrid vehicle which is configured to execute both the enlarged regeneration control and the downslope prediction control. In such a hybrid vehicle, in the case that the execution of the enlarged regeneration control is started while the downslope prediction control is executed, that is, while a traveling of the hybrid vehicle for decreasing the battery charge amount is performed, the battery charge amount may not be decreased to the small amount when the hybrid vehicle arrives at the start position of the downslope. As a result, while the hybrid vehicle travels along the downslope, the battery charge amount may reach the predetermined upper limit value. In this case, the regeneration electricity cannot be recovered to the battery any more. In this case, the start of the execution of the enlarged regeneration control for increasing the regeneration braking force leads to an increase of the deceleration of the hybrid vehicle, independently of an operation of a brake pedal by a driver of the hybrid vehicle. Thus, an unprofitable assist which may cause the driver to feel discomfort is performed. Further, when the informing for prompting the driver to release the acceleration pedal is performed as a part of the enlarged regeneration control, the informing recommends the driver to perform an unprofitable operation of the acceleration pedal.

Similarly, in the case that the execution of the downslope prediction control for decreasing the battery charge amount is started while the regeneration braking force is increased by the enlarged regeneration control, the battery charge amount may not decrease to the small amount when the hybrid vehicle arrives at the start position of the downslope. As a result, while the hybrid vehicle travels along the downslope, the battery charge amount may reach the predetermined upper limit value and thus, the regeneration electricity cannot be recovered to the battery any more. Also, in this case, the continuation of the execution of the enlarged regeneration control for increasing the regeneration braking force leads to the unprofitable assist.

The present invention has been made for solving the aforementioned problem. An object of the present invention is to provide a vehicle control apparatus applied to the hybrid vehicle, which has a function for executing both the downslope prediction control and the enlarged regeneration control without executing an unprofitable control or assist.

### SUMMARY OF THE INVENTION

A vehicle control apparatus according to the present invention is applied to a hybrid vehicle having:

a vehicle driving source including an internal combustion engine (10) and an electric motor (12); and

a battery (14) charged with electricity generated by the electric motor (12), the battery (14) supplying the electricity to the electric motor (12).

The vehicle control apparatus according to the present invention comprises a control section (50) configured to control an operation of the internal combustion engine (10) and an activation of the electric motor (12). Hereinafter, the vehicle control apparatus according to the present invention will be referred to as “the invention control apparatus”.

The control section (50) includes normal regeneration control means, enlarged regeneration control means and downslope prediction control means described below.

The normal regeneration control means is configured to execute a normal regeneration control for applying a regeneration braking force to at least one vehicle wheel (19) of the hybrid vehicle by using the electric motor (12) and charging the battery (14) with the electricity generated by the electric motor (12) (see processes of steps 855 and 885 of FIG. 8, a step 950 of FIG. 9 and steps 1040 to 1050 of FIG. 10) when an acceleration operation amount (AP) which is an amount of an operation of an acceleration operator (35) is zero (see a determination “No” at a step 910 of FIG. 9).

The enlarged regeneration control means is configured to execute an enlarged regeneration control for applying an increased regeneration braking force which is the regeneration braking force larger than the regeneration braking force applied by the normal regeneration control to the at least one vehicle wheel (19) and charging the battery (14) with the electricity generated by the electric motor (12) (see processes of step 870 of FIG. 8, the step 950 of FIG. 9 and the steps 1045 and 1050 of FIG. 10) when a position (Pend) where it is predicted that a deceleration of the hybrid vehicle ends is set as a target deceleration end position (Ptgt) where the deceleration of the hybrid vehicle ends (see a process of a step 810) and the acceleration operation amount (AP) is zero (see a determination “No” at the step 910).

The downslope prediction control means is configured to execute a downslope prediction control for controlling the activation of the electric motor (12) and the operation of the internal combustion engine (10) (see a routine of FIG. 11, in particular, a process of a step 1150 and a routine of FIG. 9, in particular, processes of steps 927 to 940) when the downslope prediction control means determines that a control execution downslope zone which satisfies a predetermined downslope zone condition exists on a scheduled traveling route of the hybrid vehicle such that a first battery charge amount becomes smaller than a second battery charge amount, the first battery charge amount being an amount of the electricity charged in the battery (14) upon arrival of the hybrid vehicle at a start position of the control execution downslope zone when it is determined that the control execution downslope zone exists on the scheduled traveling route, the second battery charge amount being the amount of the electricity charged in the battery (14) upon the arrival of the hybrid vehicle a position corresponding to the start position of the control execution downslope zone when it is not determined that the control execution downslope zone exists on the scheduled traveling route;

The enlarged regeneration forbiddance means is configured to forbid an execution of the enlarged regeneration control (see processes of steps 845 and 850 of FIG. 8, the process of the step 855, a process of a step 1035 of FIG. 10 and the processes of the step 1040) when both a condition for executing the downslope prediction control and a condition for executing the enlarged regeneration control are satisfied.

Thereby, when a situation that the downslope prediction control should be executed occurs, the enlarged regeneration control is not executed. The situation that the downslope prediction control should be executed is a situation that it is desired that the battery charge amount decreases sufficiently before the hybrid vehicle arrives at the start position of the control execution downslope zone. Therefore, under such a situation, the execution of the enlarged regeneration control for increasing the battery charge amount means an execution of an unprofitable control (i.e., an unprofitable assist).

According to the invention apparatus, when the downslope prediction control should be executed in order to decrease the battery charge amount, the enlarged regeneration control for increasing the battery charge amount is not executed. For example, according to the invention apparatus, even when the target deceleration end position is set while the downslope prediction control is executed, that is, while the hybrid vehicle travels along the pre-downslope zone, the execution of the enlarged regeneration control is not started. Further, for example, when the hybrid vehicle moves into the pre-downslope zone corresponding to the control execution downslope zone while the enlarged regeneration control is executed, the execution of the enlarged regeneration control is terminated immediately and the execution of the downslope prediction control is started. As a result, the start of the execution of the enlarged regeneration control for increasing the battery charge amount while the downslope prediction control for decreasing the battery charge amount is executed, that is, the performance of the unprofitable assist, can be prevented.

Further, the enlarged regeneration control means may be configured to execute the enlarged regeneration control:

to perform an informing for prompting a driver of the hybrid vehicle to release the acceleration operator (35) (see a process of a step 860 of FIG. 8) when the hybrid vehicle arrives at a predetermined first position before the target deceleration end position (Ptgt) with the target deceleration end position (Ptgt) being set; and

to apply the increased regeneration braking force to the at least one vehicle wheel (19) after the hybrid vehicle arrives at a predetermined second position between the predetermined first position and the target deceleration end position (Ptgt) (see the processes of the step 870 of FIG. 8 and the steps 1045 and 1050 of FIG. 10).

The performance of the informing for prompting the driver to release the acceleration operator increases a possibility that the driver releases the acceleration operator early. As a result, the execution of the enlarged regeneration control is likely to be started early. Therefore, the increased amount of the electricity can be charged in the battery by the enlarged regeneration control before the hybrid vehicle arrives at the target deceleration end position.

In the above description, for facilitating understanding of the present invention, elements of the present invention corresponding to elements of an embodiment described later are denoted by reference symbols used in the description of the embodiment accompanied with parentheses. However, the elements of the present invention are not limited to the elements of the embodiment defined by the reference symbols. The other objects, features and accompanied advantages of the present invention can be easily understood from the description of the embodiment of the present invention along with the drawings.

### BRIEF DESCRIPTION OF THE DRAWINGS

FIG. 1 is a general system configuration view for showing a vehicle control apparatus applied to a hybrid vehicle according to an embodiment of the present invention.

FIG. 2 is a view for showing a look-up table to be used for acquiring a requested torque.

FIG. 3 is a view used for describing an enlarged regeneration control (i.e., a deceleration prediction assist control).

FIG. 4 is a view used for describing the enlarged regeneration control.

FIG. 5 is a view for showing a part of a look-up table to be used for acquiring the requested torque.

FIG. 6 is a view for showing a time chart used for describing a downslope prediction control and the enlarged regeneration control.

FIG. 7 is a view for showing a time chart used for describing the downslope prediction control and the enlarged regeneration control.

FIG. 8 is a view for showing a flowchart of a routine executed by a CPU of an assist control section shown in FIG. 1.

FIG. 9 is a view for showing a flowchart of a routine executed by a CPU of a PM control section shown in FIG. 1.

FIG. 10 is a view for showing a flowchart of a routine executed by the CPU of the PM control section.

FIG. 11 is a view for showing a flowchart of a routine executed by the CPU of the assist control section.

FIG. 12 is a view for showing a flowchart of a part of a routine executed by the CPU of the assist control section according to a modified example of the embodiment of the present invention.

FIG. 13 is a view for showing a flowchart of a part of a routine executed by the CPU of the PM control section according to the modified example.

### DESCRIPTION OF THE PREFERRED EMBODIMENTS

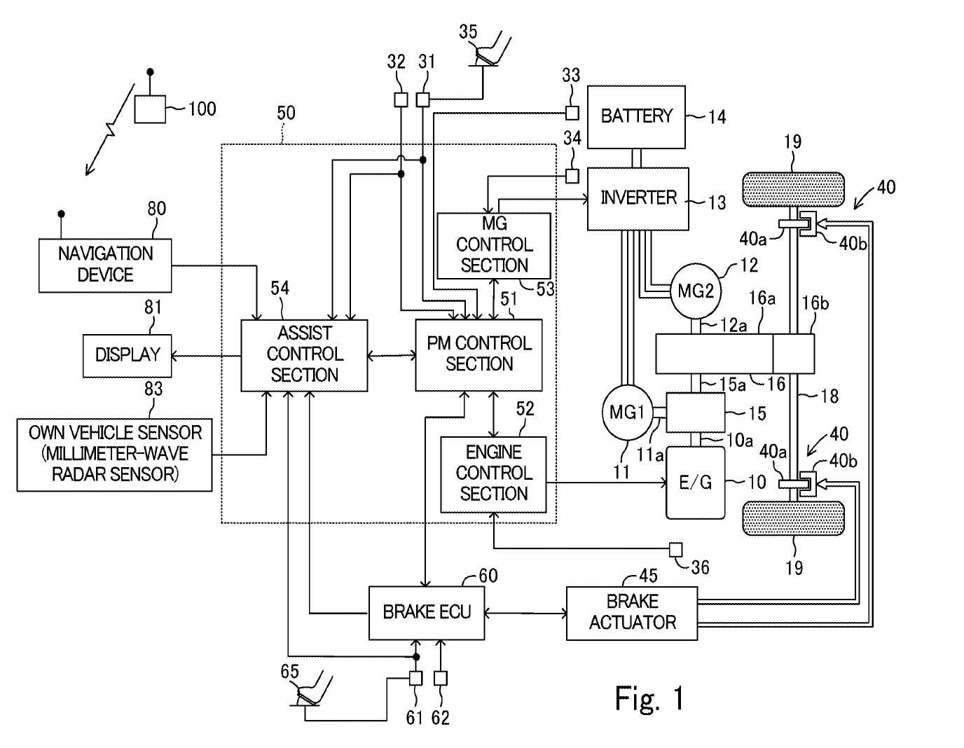

Below, a vehicle control apparatus according to an embodiment of the present invention will be described with reference to the drawings. Hereinafter, the vehicle control apparatus according to the embodiment will be referred to as “the embodiment control apparatus”. As shown in FIG. 1, a vehicle, on which the embodiment control apparatus is installed, is a hybrid vehicle. Hereinafter, this vehicle will be referred to as “the own vehicle”.

The own vehicle has, as travel driving apparatus, an internal combustion engine 10 as a vehicle driving source, a first motor generator 11 (i.e., a first electric motor 11) as the vehicle driving source, and a second motor generator 12 (i.e., a second electric motor 12) as the vehicle driving source, an inverter 13, a rechargeable battery 14, a power distribution mechanism 15, a power transmission mechanism 16 and a hybrid electronic control unit 50.

The engine 10 is a gasoline internal combustion engine (i.e., a spark ignition type internal combustion engine). However, the engine 10 may be a diesel internal combustion engine (i.e., a compression ignition type internal combustion engine).

The power distribution mechanism 15 distributes a torque output from the engine 10 to a torque for rotating an output shaft 15a of the power distribution mechanism 15 and a torque for driving the first motor generator 11 as an electric generator with a predetermined ratio (i.e., a predetermined distribution property). Hereinafter, the torque output from the engine 10 will be referred to as “the engine torque” and the first motor generator 11 will be referred to as “the first MG 11”.

The power distribution mechanism 15 is constituted by a planetary gear mechanism (not shown). The planetary gear mechanism has at least one sun gear, pinion gears, at least one planetary carrier and at least one ring gear (not shown).

A rotation shaft of the planetary carrier is connected to an output shaft 10a of the engine 10. The rotation shaft of the planetary carrier transmits the engine torque to the sun gear and the ring gear through the pinion gears. A rotation shaft of the sun gear is connected to a rotation shaft 11a of the first MG 11. The rotation shaft of the sun gear transmits the engine torque input into the sun gear to the first MG 11. When the engine torque is transmitted from the sun gear to the first MG 11, the first MG 11 is rotated by the transmitted engine torque to generate electricity. A rotation shaft of the ring gear is connected to an output shaft 15a of the power distribution mechanism 15 and the engine torque input into the ring gear is transmitted from the power distribution mechanism 15 to the power transmission mechanism 16 through the output shaft 15a.

The power transmission mechanism 16 is connected to the output shaft 15a of the power distribution mechanism 15 and a rotation shaft 12a of the second motor generator 12. Hereinafter, the second motor generator 12 will be referred to as “the second MG 12”. The power transmission mechanism 16 includes a reduction gear train 16a and a differential gear 16b.

The reduction gear train 16a is connected to a vehicle wheel drive shaft 18 through the differential gear 16b. Therefore, the engine torque input into the power transmission mechanism 16 from the output shaft 15a of the power distribution mechanism 15 and the engine torque input into the power transmission mechanism 16 from the rotation shaft 12a of the second MG 12 are transmitted to right and left front vehicle wheels 19, which are drive wheels, respectively, through the vehicle wheel drive shaft 18. In this regard, the drive wheels 19 may be right and left rear vehicle wheels and may be right and left front and rear vehicle wheels.

It should be noted that the power distribution mechanism 15 and the power transmission mechanism 16 are known (for example, see JP 2013-177026 A).

The first and second MGs 11 and 12 are permanent magnet synchronous motors, respectively. The first and second MGs 11 and 12 are electrically connected to the inverter 13. The inverter 13 has first and second inverter circuits, separately. The first inverter circuit drives the first MG 11 and the second inverter circuit drives the second MG 12.

When the first MG 11 should be activated as a motor, the inverter 13 converts direct current electricity supplied from the battery 14 to three-phase alternating current electricity. Then, the inverter 13 supplies the three-phase alternating current electricity to the first MG 11. On the other hand, when the second MG 12 should be activated as a motor, the inverter 13 converts direct current electricity supplied from the battery 14 to three-phase alternating current electricity. Then, the inverter 13 supplies the three-phase alternating current electricity to the second MG 12.

When the rotation shaft 11a of the first MG 11 is rotated by external force such as traveling energy of the own vehicle or the engine torque, the first MG 11 is activated as an electric generator to generate the electricity. When the first MG 11 is activated as the electric generator, the inverter 13 converts the three-phase alternating current electricity generated by the first MG 11 to the direct current electricity. Then, the inverter 13 charges the battery 14 with the direct current electricity.

When the traveling energy of the own vehicle is input as the external force into the first MG 11 from the driving wheels 19 through the vehicle wheel drive shaft 18, the power transmission mechanism 16 and the power distribution mechanism 15, regeneration braking force (or regeneration braking torque) is applied to the driving wheels 19 by the first MG 11.

When the rotation shaft 12a of the second MG 12 is rotated by the external force, the second MG 12 is activated as the electric generator to generate the electricity. When the second MG 12 is activated as the electric generator, the inverter 13 converts the three-phase alternating current electricity generated by the second MG 12 to the direct current electricity. Then, the inverter 13 charges the battery 14 with the direct current electricity.

When the traveling energy of the own vehicle is input as the external force into the second MG 12 from the drive wheels 19 through the vehicle wheel drive shaft 18 and the power transmission mechanism 16, the regeneration braking force (or the regeneration braking torque) is applied to the driving wheels 19 by the second MG 12.

The hybrid electronic control unit 50 has a power management control section 51, an engine control section 52, a motor generator control section 53 and an assist control section 54. Hereinafter, the hybrid electronic control unit 50 will be simply referred to as “the control unit 50”. Each of the control sections 51, 52, 53 and 54 has, as a main part, a microcomputer including a CPU, a ROM (or a memory), a RAM, a back-up RAM (or a non-volatile memory) and the like. The CPU of each of the control sections 51, 52, 53 and 54 is configured or programmed to execute instructions or programs stored in the ROMs of the control sections 51, 52, 53 and 54, respectively to realize various functions described later.

The power management control section 51 is electrically connected to the engine control section 52 and the motor generator control section 53 such that the power management control section 51 can send and receive information or signals to and from the engine control section 52 and the motor generator control section 53. Hereinafter, the power management control section 51 will be referred to as “the PM control section 51”. The PM control section 51, the engine control section 52 and the motor generator control section 53 acquire detection values of sensors described later on the basis of signals sent from the sensors.

The PM control section 51 is electrically connected to an acceleration pedal operation amount sensor 31, a vehicle speed sensor 32 and a battery sensor 33. The acceleration pedal operation amount sensor 31 outputs a signal representing an amount AP of an operation of an acceleration pedal 35 as an acceleration operator to the PM control section 51. Hereinafter, the amount AP will be referred to as “the acceleration pedal operation amount AP”. The vehicle speed sensor 32 outputs a signal representing a traveling speed V of the own vehicle to the PM control section 51. Hereinafter, the traveling speed V will be referred to as the own vehicle speed V″.

The battery sensor 33 includes an electric current sensor, an electric voltage sensor and a temperature sensor. The electric current sensor of the battery sensor 33 outputs a signal representing an electric current flowing into the battery 14 or flowing out from the battery 14 to the PM control section 51. The electric voltage sensor of the battery sensor 33 outputs a signal representing an electric voltage of the battery 14 to the PM control section 51. The temperature sensor of the battery sensor 33 outputs a signal representing temperature of the battery 14 to the PM control section 51.

Further, the PM control section 51 calculates an amount of the electricity flowing into the battery 14 (i.e., a charged electricity amount) by a known method on the basis of the electric current flowing into the battery 14, the electric voltage of the battery 14 and the temperature of the battery 14. In addition, the PM control section 51 calculates an amount of the electricity flowing out from the battery 14 (i.e., a discharged electricity amount) on the basis of the electric current flowing out from the battery 14, the electric voltage of the battery 14 and the temperature of the battery 14. The PM control section 51 calculates or acquires an electricity amount SOC (State Of Charge) charged in the battery 14 by integrating the charged and discharged electricity amounts. Hereinafter, the electricity amount SOC will be referred to as “the battery charge amount SOC”.

The engine control section 52 is electrically connected to various engine sensors 36 for detecting parameters representing operation states of the internal combustion engine 10, respectively. Further, the engine control section 52 is electrically connected to various engine actuators such as a throttle valve actuator, fuel injectors and ignition device (not shown) for controlling an operation of the engine 10. The engine control section 52 controls the engine actuators of the engine 10 to control the operation of the engine 10 (i.e., the engine torque generated by the engine 10 and an engine speed of the engine 10).

The motor generator control section 53 is electrically connected to MG sensors 34 such as a first rotation angle sensor, a second rotation angle sensor, a first electric voltage sensor, a second electric voltage sensor, a first electric current sensor, a second electric current sensor and a temperature sensor. Signals (or output values) output from the MG sensors 34 are used for controlling the first and second MGs 11 and 12. The motor generator control section 53 controls the inverter 13 to control activations of the first and second MGs 11 and 12. Hereinafter, the motor generator control section 53 will be referred to as “the MG control section 53”.

The first rotation angle sensor of the MG sensors 34 outputs a signal representing a rotation angle of the first MG 11 to the MG control section 53. The second rotation angle sensor of the MG sensors 34 outputs a signals representing a rotation angle of the second MG 12 to the MG control section 53.

The first electric voltage sensor of the MG sensors 34 outputs a signal representing an electric voltage applied from the battery 14 to the first MG 11 through the inverter 13 or applied from the first MG 11 to the battery 14 through the inverter 13 to the MG control section 53.

The second electric voltage sensor of the MG sensors 34 outputs a signal representing an electric voltage applied from the battery 14 to the second MG 12 through the inverter 13 or applied from the second MG 12 to the battery 14 through the inverter 13 to the MG control section 53.

The first electric current sensor of the MG sensors 34 outputs a signal representing an electric current flowing into the first MG 11 from the battery 14 through the inverter 13 or flowing into the battery 14 from the first MG 11 through the inverter 13 to the MG control section 53.

The second electric current sensor of the MG sensors 34 outputs a signal representing an electric current flowing into the second MG 12 from the battery 14 through the inverter 13 or flowing into the battery 14 from the second MG 12 through the inverter 13 to the MG control section 53.

The assist control section 54 has, as a main part, a microcomputer including a CPU, a ROM (or a memory), a RAM, a back-up RAM (or a non-volatile memory) and the like. The assist control section 54 is electrically connected to the acceleration pedal operation amount sensor 31, the vehicle speed sensor 32, a brake sensor 61, a navigation device 80, a display device 81 and an own vehicle sensor 83.

The brake sensor 61 outputs a signal representing an amount BP of an operation of a brake pedal 65 to the assist control section 54 and a brake electronic control unit 60. Hereinafter, the amount BP will be referred to as “the brake pedal operation amount BP”.

The navigation device 80 has a GPS sensor, an acceleration sensor, a wireless communication device, a memory device, a display panel (including a sound generation device), a main control section and the like.

The GPS sensor detects a present position P of the own vehicle on the basis of radio wave from a GPS satellite. The acceleration sensor detects a traveling direction of the own vehicle.

The wireless communication device receives road information and the like sent from the outside of the own vehicle. The memory device stores another road information including a map data, the road information received by the wireless communication device and the like. The display panel provides a driver of the own vehicle with various information. The main control section calculates a scheduled traveling route to a destination which is set by the driver, an arrival time when the own vehicle arrives at the destination and the like. Then, the main control section displays the calculated scheduled traveling route, the calculated arrival time and the like on the display panel.

The road information includes road map information, road category information, road gradient information, altitude information, road shape information, legal limit speed information, intersection position information, stop line position information, traffic light information and traffic congestion information.

Further, the navigation device 80 acquires the traffic light information and the traffic congestion information on the basis of signals sent from external communication devices 100 such as beacons installed along the road.

The display device 81 is provided in front of a driver's seat of the own vehicle. A display area for displaying an acceleration pedal release prompting display (i.e., a display area for performing an informing for prompting the driver to release the acceleration pedal 35 as an acceleration operator described later) is formed in the display device 81. The acceleration pedal release prompting display displayed by the display device 81 may be a display capable of prompting the driver to release the acceleration pedal 35 and various kinds of displays such as illustrations, marks and characters may be employed as the acceleration pedal release prompting display. Further, a configuration for informing the driver by a sound generation device (for example, a voice announcement) as well as a configuration for informing the driver by the display device 81 may be employed as the acceleration pedal release prompting display.

The own vehicle sensor 83 is a known millimeter wave radar sensor. The own vehicle sensor 83 sends a millimeter wave (i.e., an output wave) ahead of the own vehicle. When there is a vehicle traveling in front of the own vehicle, the millimeter wave is reflected by the vehicle traveling in front of the own vehicle. The own vehicle sensor 83 receives the reflected wave. Hereinafter, the vehicle traveling in front of the own vehicle will be referred to as “the preceding vehicle”.

The assist control section 54 detects or traps the preceding vehicle on the basis of the reflected wave received by the own vehicle sensor 83. Further, the assist control section 54 acquires a difference (i.e., a relative speed) between the own vehicle speed V and a traveling speed of the preceding vehicle, a distance (i.e., an inter-vehicle distance) between the own vehicle and the preceding vehicle, an orientation (i.e., a relative orientation) of the preceding vehicle with respect to the own vehicle and the like on the basis of a phase difference between the millimeter wave sent from the own vehicle sensor 83 and the received reflected wave, a damping level of the reflected wave, a detection time of the reflected wave and the like.

The own vehicle has friction brake mechanisms 40, a brake actuator 45 and the brake electronic control unit 60. The friction brake mechanisms 40 are provided at the right and left drive wheels 19 and the right and left rear vehicle wheels (not shown). FIG. 1 shows the friction brake mechanisms 40 provided at the right and left drive wheels 19. Each of the friction brake mechanisms 40 has a brake disc 40a mounted on the corresponding vehicle wheel and a brake caliper 40b mounted on the body of the own vehicle. Each of the friction brake mechanisms 40 activates a wheel cylinder built (not shown) in the brake caliper 40b by a pressure of a hydraulic oil supplied from the brake actuator 45 to press a brake pad (not shown) against the brake disc 40a to generate the friction braking force or torque. Hereinafter, the pressure of the hydraulic oil will be referred to as “the hydraulic pressure”.

The brake actuator 45 is a known actuator for independently adjusting the hydraulic pressure supplied to the wheel cylinder built in the brake caliper 40b of each of the vehicle wheels. The brake actuator 45 has, for example, a depression force hydraulic pressure circuit and a control hydraulic pressure circuit. The depression force hydraulic pressure circuit supplies the hydraulic oil from a master cylinder (not shown) to the wheel cylinders. The master cylinder pressurizes the hydraulic oil by a depression force (a brake pedal depression force) of the driver against the brake pedal 65. The control hydraulic pressure circuit supplies controllable control hydraulic pressure to each of the wheel cylinders, independently of the brake pedal depression force.

The control hydraulic pressure circuit has a dynamic hydraulic pressure generation device, control valves, hydraulic pressure sensors and the like. Elements constituting the brake actuator 45 are not shown. The dynamic hydraulic pressure generation device includes a boost pump and an accumulator. The dynamic hydraulic pressure generation device generates a high hydraulic pressure. Each of the control valves adjusts the hydraulic pressure output from the dynamic hydraulic pressure generation device and supplies the hydraulic pressure controlled to a target hydraulic pressure to the corresponding wheel cylinder. Each of the hydraulic pressure sensors detects the hydraulic pressure of the corresponding hydraulic cylinder. An actuator described, for example, in the JP 2014-19247 A or the like can be used as the brake actuator 45.

The brake electronic control unit 60 has a microcomputer as a main part. The microcomputer includes a CPU, a ROM (or a memory), a RAM, a back-up RAM (or a non-volatile memory) and the like. The brake electronic control unit 60 can send and receive information to and from the PM control section 51 of the control unit 50. The brake electronic control unit 60 is electrically connected to the brake sensor 61 and vehicle wheel speed sensors 62. The brake electronic control unit 60 acquires detection values output from the brake sensor 61 and the vehicle wheel speed sensors 62. Hereinafter, the brake electronic control unit 60 will be referred to as “the brake ECU 60”.

Each of the vehicle wheel speed sensors 62 outputs a signal representing vehicle wheel speed ωh of the corresponding vehicle wheel to the brake ECU 60.

<Normal Acceleration/Deceleration Control>

Next, a normal acceleration/deceleration control including a normal regeneration control executed by the embodiment control apparatus (in particular, the control unit 50) will be described. The PM control section 51 of the embodiment control apparatus acquires the rotation angle of the second MG 12 acquired by the MG control section 53. The PM control section 51 acquires a rotation speed NM2 of the second MG 12 on the basis of the acquired rotation angles. Hereinafter, the rotation speed NM2 will be referred to as the second MG rotation speed NM2″.

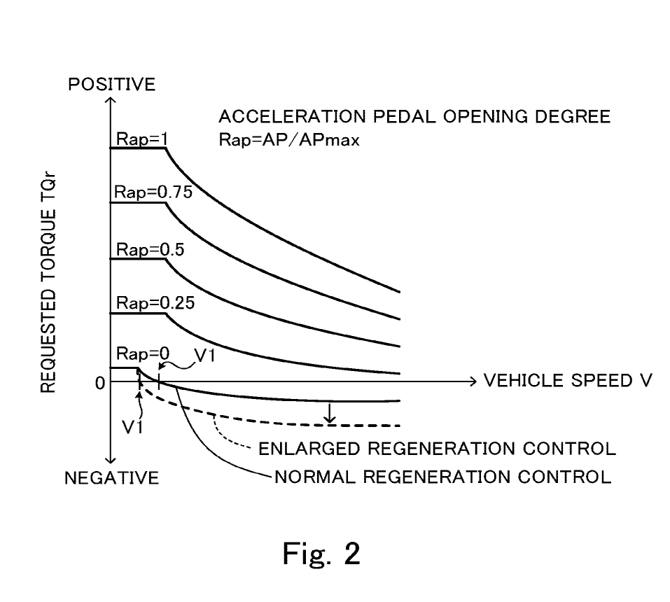

Further, the PM control section 51 applies the acceleration pedal operation amount AP and the own vehicle speed V of the own vehicle to a look-up table MapTQr(AP,V) used for the normal acceleration/deceleration control shown by a solid line in FIG. 2 to acquire a requested torque TQr. The requested torque TQr is a torque requested by the driver of the own vehicle as a driving torque to be supplied to the drive wheels 19 to drive the drive wheels 19.

According to the look-up table MapTQr(AP,V), the requested torque TQr increases as a ratio Rap of the acceleration pedal operation amount AP with respect to a maximum value APmax of the acceleration pedal operation amount AP increases (Rap=AP/APmax) when the own vehicle speed V is constant.

Further, according to the look-up table MapTQr(AP, V) for the normal acceleration/deceleration control, the acquired requested torque TQr is a constant positive value when the acceleration pedal opening degree Rap (i.e., the acceleration pedal operation amount AP) is constant and the own vehicle speed V is equal to or smaller than a predetermined vehicle speed larger than zero. Further, the acquired requested torque TQr decreases as the own vehicle speed V increases when the acceleration pedal opening degree Rap is constant and the own vehicle speed V is larger than the predetermined vehicle speed.

In particular, according to the look-up table MapTQr(AP,V) for the normal acceleration/deceleration control, the requested torque TQr is a negative value and an absolute value of the requested torque TQr increases as the own vehicle speed V increases when the acceleration pedal operation amount AP is zero (that is, an acceleration pedal opening degree is zero) and the own vehicle speed V is larger than a vehicle speed V1 larger than the aforementioned threshold vehicle speed. In this case, the requested torque TQr is a regeneration braking torque (or a normal regeneration braking torque or a normal regeneration braking force) required for braking the driving wheels 19 of the own vehicle by the second MG 12. Hereinafter, the vehicle speed V1 will be referred to as “the switching vehicle speed V1”.

When the acceleration pedal operation amount AP is larger than zero, the PM control section 51 calculates an output power Pr* to be input into the drive wheels 19 by multiplying the requested torque TQr by the second MG rotation speed NM2 (Pr*=TQr·NM2). Hereinafter, the output power Pr* will be referred to as “the requested driving output power Pr*”.

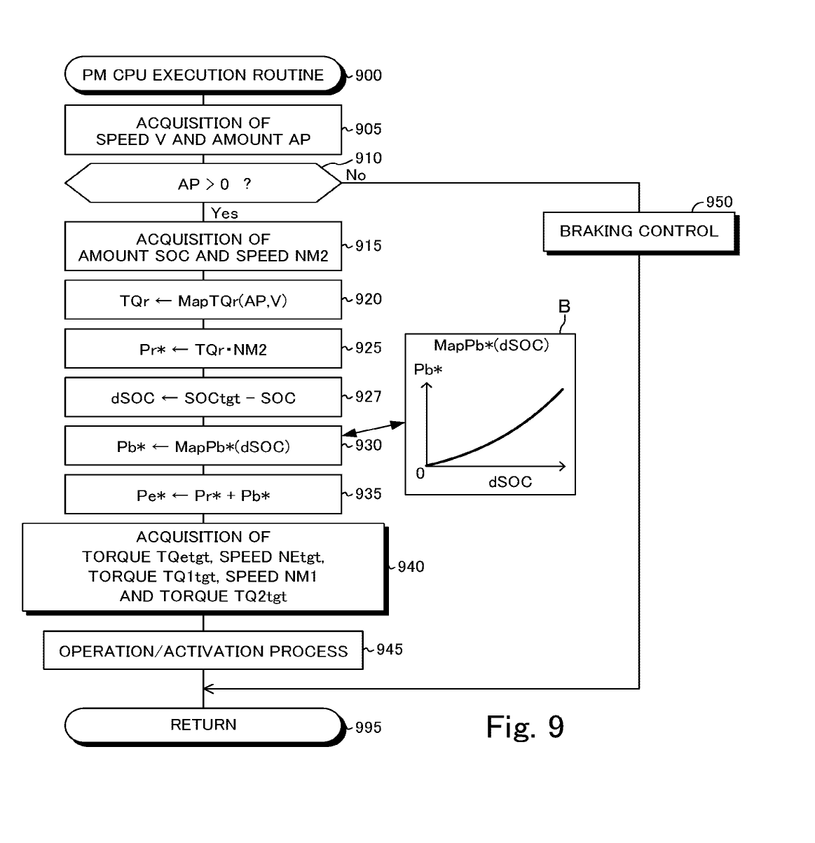

Further, the PM control section 51 acquires an output power Pb* to be input into the first MG 11 for causing the battery charge amount SOC to approach a target value SOCtgt of the battery charge amount SOC on the basis of a difference dSOC between the target value SOCtgt of the battery charge amount SOC and the present battery charge amount SOC (dSOC=SOCtgt−SOC). Hereinafter, the target value SOCtgt will be referred to as “the target charge amount SOCtgt” and the output power Pb* will be referred to as “the requested charge output power Pb*”. The requested charge output power Pb* increases as the charge amount difference dSOC increases (see a block B in FIG. 9).

The PM control section 51 calculates a sum of the requested driving output power Pr* and the requested charge output power Pb* as an output power Pe* to be output from the engine 10 (Pe*=Pr*+Pb*). Hereinafter, the output power Pe* will be referred to as “the requested engine output power Pe*”.

The PM control section 51 determines whether or not the requested engine output power Pe* is smaller than a lower limit value of an optimum operation output power of the engine 10. The lower limit value of the optimum operation output power of the engine 10 is a minimum value of an output power capable of causing the engine 10 to operate at an efficiency equal to or larger than a predetermined efficiency. The optimum operation output power is defined by a combination of an optimum engine torque TQeop and an optimum engine speed NEeop.

When the requested engine output power Pe* is smaller than the lower limit value of the optimum operation output power of the engine 10, the PM control section 51 sets a target value TQetgt of the engine torque and a target value NEtgt of the engine speed to zero, respectively. Hereinafter, the target value TQetgt will be referred to as “the target engine torque TQetgt” and the target value NEtgt will be referred to as “the target engine speed NEtgt”. The PM control section 51 sends the target engine torque TQetgt and the target engine speed NEtgt to the engine control section 52.

Further, the PM control section 51 calculates a target value TQ2tgt to be output from the second MG 12 for supplying an output power corresponding to the requested driving output power Pr* to the drive wheels 19 on the basis of the second MG rotation speed NM2. Hereinafter, the target value TQ2tgt will be referred to as “the target second MG torque TQ2tgt”. The PM control section 51 sends the target second MG torque TQ2tgt to the MG control section 53.

On the other hand, when the requested engine output power Pe* is equal to or larger than the lower limit value of the optimum operation output power of the engine 10, the PM control section 51 sets target values of the optimum engine torque TQeop and the optimum engine speed NEeop capable of outputting an output power corresponding to the requested engine output power Pe* from the engine 10 as the target engine torque TQetgt and the target engine speed NEtgt, respectively. The PM control section 51 sends the target engine torque TQetgt and the target engine speed NEtgt to the engine control section 52.

Further, the PM control section 51 calculates the target first MG rotation speed NM1tgt on the basis of the target engine speed NEtgt and the second MG rotation speed NM2. The PM control section 51 calculates the target first MG torque TQ1tgt on the basis of the target engine torque TQetgt, the target first MG rotation speed NM1tgt, the present first MG rotation speed NM1 and a distribution property of the engine torque of the power distribution mechanism 15.

In addition, the PM control section 51 calculates the target second MG torque TQ2tgt on the basis of the requested torque TQr, the target engine torque TQetgt and the distribution property of the engine torque of the power distribution mechanism 15.

The PM control section 51 sends the target first MG rotation speed NM1tgt, the target first MG torque TQ1tgt and the target second MG torque TQ2tgt to the MG control section 53.

The engine control section 52 controls the operation of the engine 10 such that the target engine torque TQetgt and the target engine speed NEtgt sent from the PM control section 51 are achieved. When the target engine torque TQetgt and the target engine speed NEtgt are zero, respectively, the engine control section 52 stops the operation of the engine 10.

On the other hand, the MG control section 53 controls the inverter 13 to control the activations of the first and second MGs 11 and 12 such that the target first MG rotation speed NM1tgt, the target first MG torque TQ1tgt and the target second MG torque TQ2tgt sent from the PM control section 51 are achieved. At this time, when the first MG 11 generates the electricity, the second MG 12 may be activated by the electricity supplied from the battery 14 and the electricity generated by the first MG 11.

It should be noted that there is known a method for calculating the target engine torque TQetgt, the target engine speed NEtgt, the target first MG torque TQ1tgt, the target first MG rotation speed NM1tgt and the target second MG torque TQ2tgt in the own vehicle (for example, see JP 2013-177026 A).

On the other hand, when the acceleration pedal operation amount AP is zero, the PM control section 51 executes the normal regeneration control. That is, when the acceleration pedal operation amount AP is zero, the PM control section 51 sets the target engine torque TQetgt and the target engine speed NEtgt to zero, respectively. Further, the PM control section 51 sets the requested torque TQr as the target second MG torque TQ2tgt in accordance with a property shown by a solid line corresponding to Rap=0 shown in FIG. 2. When the own vehicle speed V is larger than the switching vehicle speed V1, the thus-set requested torque TQr is a negative value (i.e., the regeneration braking torque). On the other hand, when the own vehicle speed V is equal to or smaller than the switching vehicle speed V1, the requested torque TQr is a positive value (i.e., the driving torque).

The PM control section 51 sends the target engine torque TQetgt and the target engine speed NEtgt to the engine control section 52. In addition, the PM control section 51 sends the target first MG torque TQ1tgt, the target first MG rotation speed NM1tgt and the target second MG torque TQ2tgt to the MG control section 53.

In this case, the engine control section 52 stops the operation of the engine 10. The MG control section 53 controls the activation of the second MG 12 such that the target second MG torque TQ2tgt is achieved.

<Friction Braking Control>

Next, a friction braking control executed by the embodiment control apparatus will be described. The brake ECU 60 of the embodiment control apparatus executes the friction braking control when the brake pedal operation amount BP is larger than zero. That is, the brake ECU 60 determines a requested braking torque TQbr on the basis of the brake pedal operation amount BP.

The PM control section 51 receives the requested braking torque TQbr from the brake ECU 60. Then, the PM control section 51 calculates or acquires a target friction braking torque TQfbtgt by adding the target second MG torque TQ2tgt to the requested braking torque TQbr (TQfbtgt=TQbr+TQ2tgt). An absolute value of the calculated target friction braking torque TQfbtgt is smaller than an absolute value of the requested braking torque TQbr when the target second MG torque TQ2tgt is a negative value (i.e., the regeneration braking torque). The absolute value of the calculated target friction braking torque TQfbtgt is larger than the absolute value of the requested braking torque TQbr when the target second MG torque TQ2tgt is a positive value (i.e., the a driving torque).

The brake ECU 60 receives the target friction braking torque TQfbtgt from the PM control section 51. The brake ECU 60 controls an activation of the brake actuator 45 such that a braking torque corresponding to one quarter of the target friction braking torque TQfbtgt is applied to each of the four vehicle wheels including the drive wheels 19.

It should be noted that when the brake pedal operation amount BP is larger than zero, the acceleration pedal operation amount AP is zero and thus, the engine control section 52 stops the operation of the engine 10.

<Downslope Prediction Control>

Next, a downslope prediction control executed by the embodiment control apparatus will be described. The assist control section 54 of the embodiment control apparatus determines whether or not a downslope zone exists along a scheduled vehicle traveling road (route) on the basis of the present position P of the own vehicle and road information acquired through the navigation device 80. The scheduled vehicle traveling road is a road which exists within a predetermined distance from the present position P of the own vehicle and along which the own vehicle travels. The downslope zone satisfies a following downslope zone condition.

[Downslope Zone Condition]

The downslope zone condition is that a distance between start and end positions of the downslope zone is larger than a threshold distance Dth1 and an altitude of the start position of the downslope zone is higher than the altitude of the end position of the downslope zone by a threshold height Hth. In other words, the downslope zone condition is that the distance between the start and end positions of the down slope zone is larger than the threshold distance Dth1, the altitude of the start position of the downslope zone is higher than the altitude of the end position of the downslope zone and an absolute value of a difference between the altitude of the start position of the downslope zone and the altitude of the end position of the downslope zone is larger than the threshold height Hth.

When such a downslope zone exists, the assist control section 54 sets the downslope zone as a control execution downslope zone. In addition, the assist control section 54 sets a position before the start position of the control execution downslope zone by a predetermined distance as a start position of a pre-downslope zone. It should be noted that an end position of the pre-downslope zone corresponds to the start position of the control execution downslope zone. When the own vehicle arrives at the start position of the pre-downslope zone, the assist control section 54 informs the PM control section 51 of the arrival of the own vehicle at the start position of the pre-downslope zone. When the PM control section 51 is informed of the arrival of the own vehicle at the start position of the pre-downslope zone, the PM control section 51 starts to execute the downslope prediction control. In particular, the PM control section 51 sets a target charge amount SOCtgt to a value SOClow smaller than the target charge amount SOCtgt set in the normal acceleration/deceleration control and controls the operation of the engine 10 and activations of the first and second MGs 11 and 12. It should be noted that the target charge amount SOCtgt set in the normal acceleration/deceleration control is a standard target value SOCstd. Therefore, the value SOClow is smaller than the standard target value SOCstd. Hereinafter, the value SOClow will be referred to as “the low target value SOClow”

Thereby, the requested engine output Pb*, i.e., the requested charge output Pb* acquired on the basis of the charge amount difference dSOC between the present battery charge amount SOC and the target charge amount SOCtgt (dSOC=SOCtgt−SOC) and the like is smaller than the requested charge output Pb* acquired in the normal acceleration/deceleration control even when the battery charge amount SOC is the same. Therefore, the requested engine output Pe* (=Pr*+Pb*) decreases and thus, an opportunity that the engine 10 is operated decreases. Thereby, the output from the second MG 12 in the downslope prediction control becomes larger than the output from the second MG 12 in the normal acceleration/deceleration control. In addition, the amount of the electricity generated by the first MG 11 and charged in the battery 14 in the downslope prediction control becomes smaller than the amount of the electricity generated by the first MG 11 and charged in the battery 14 in the normal acceleration/deceleration control. Therefore, during the execution of the downslope prediction control, the battery charge amount SOC becomes smaller than the battery charge amount SOC in the normal acceleration/deceleration control.

When the own vehicle arrives at the end position of the control execution downslope zone, the assist control section 54 informs the PM control section 51 of the arrival of the own vehicle at the end position of the control execution downslope zone. When the PM control section 51 is informed of the arrival of the own vehicle at the end position of the control execution downslope zone, the PM control section 51 terminates the execution of the downslope prediction control. In particular, the PM control section 51 returns the target charge amount SOCtgt to the target charge amount SOCtgt set in the normal acceleration/deceleration control. In other words, the PM control section 51 sets the target charge amount SOCtgt to the standard target value SOCstd. In this regard, the PM control section 51 may be configured or programmed to terminate the execution of the downslope prediction control when the own vehicle arrives at the start position of the control execution downslope zone, i.e., the end position of the pre-downslope zone. Thereby, the target charge amount SOCtgt is returned to the target charge amount SOCtgt set in the normal acceleration/deceleration control.

<Deceleration Prediction Assist Control>

Next, a deceleration prediction assist control including an enlarged regeneration control executed by the embodiment control apparatus will be described. For example, when a momentary stop line is provided on a scheduled vehicle traveling road, the driver of the own vehicle normally releases the acceleration pedal 35 first and next, operates the brake pedal 65 to stop the own vehicle at the momentary stop line. In this case, if regeneration braking torques applied to the drive wheels 19, respectively by the second MG 12 is increased upon the release of the acceleration pedal 35, the amount of the electricity recovered to the battery 14 until the start of the operation of the brake pedal 65 from the time when the acceleration pedal 35 is released, increases.

Further, if the regeneration braking torque is increased upon the release of the acceleration pedal 35, a deceleration of the own vehicle is increased and thus, the operation of the brake pedal 65 may be started at a position more closely to the momentary stop line. Otherwise, even when the operation of the brake pedal 65 is started at the same position as the case that the regeneration braking torque is not increased, the own vehicle speed V upon the start of the operation of the brake pedal 65 is small. Therefore, thermal energy consumed in the friction braking decreases. For the reasons described above, the amount of the electricity recovered to the battery 14 is increased.

The assist control section 54 executes the deceleration prediction assist control for assisting the driver of the own vehicle in cooperation with the PM control section 51 such that the amount of the electricity recovered to the battery 14 is increased.

In particular, the assist control section 54 learns positions on the map where the brake pedal 65 is released with a high frequency on the basis of a history of a daily driving of the driver of the own vehicle. Then, the assist control section 54 stores or learns or registers the learned positions as deceleration end positions Pend, respectively in the back-up RAM of the assist control section 54. Further, the assist control section 54 stores or learns or registers the own vehicle speed V acquired upon arrival of the own vehicle at each of the deceleration end positions Pend as a deceleration end vehicle speed Vend in the back-up RAM of the assist control section 54 in association with the corresponding deceleration end position Pend.

The assist control section 54 acquires the brake pedal operation amount BP, the own vehicle speed V and a position P (including a traveling direction) of the own vehicle detected by the navigation device 80 when an ignition switch of the own vehicle is positioned at an ON-position in order to learn the deceleration end position Pend and the deceleration end vehicle speed Vend. Hereinafter, the position P will be referred to as “the own vehicle position P”.

Each time the assist control section 54 detects that the brake pedal 65 is released on the basis of the brake pedal operation amount BP, the assist control section 54 stores the present own vehicle position P and the present own vehicle speed V in the back-up RAM of the assist control section 54 in association with each other. The assist control section 54 calculates a frequency of the release of the brake pedal 65 at each of the stored own vehicle positions P and extracts the own vehicle positions P each having the frequency higher than a threshold. The assist control section 54 stores the extracted vehicle positions P in the back-up RAM of the assist control section 54 as the deceleration end positions Pend, respectively and stores an average of the own vehicle speeds V stored in association with each of the deceleration end positions Pend in the back-up RAM of the assist control section 54 as a deceleration end vehicle speed Vend.

Further, the assist control section 54 reads the traffic light information received by the navigation device 80 from the outside communication devices 100 each installed along the road. The traffic light information includes information on a present lighting color (green or yellow or red) of each of a traffic light, information on a position where each of the traffic lights is installed, information on a time required for the lighting color of each of the traffic lights to change from green to yellow, information on a time required for the lighting color of the traffic light to change from yellow to red and information on a time for the lighting color of the traffic light to change from red to green.

The assist control section 54 predicts a lighting state of the traffic light when the own vehicle arrives at a stop line provided at the intersection where the traffic light is installed on the basis of a distance from the present own vehicle position P to a position of the stop line at the intersection where the traffic light is installed and the present own vehicle speed V. In other words, the assist control section 54 predicts whether or not the driver of the own vehicle will stop the own vehicle at the stop line at the intersection.

When the assist control section 54 predicts that the driver will stop the own vehicle at the stop line at the intersection, the assist control section 54 stores a position of the stop line in the RAM of the assist control section 54 as the deceleration end position Pend. In addition, the assist control section 54 stores the own vehicle speed V upon arrival of the own vehicle at the deceleration end position Pend (in this case, 0 km/h) in the RAM of the assist control section 54 as the deceleration end vehicle speed Vend in association with the deceleration end position Pend.

When the assist control section 54 determines that the deceleration end position Pend exists on the scheduled traveling route within the predetermined distance (for example, hundreds of meters) from the present own vehicle position P, the assist control section 54 starts to execute the deceleration prediction assist control.

When the assist control section 54 starts to execute the deceleration prediction assist control, the assist control section 54 sets the deceleration end position Pend existing on the scheduled traveling route within the predetermined distance from the present own vehicle position P as a target deceleration end position Ptgt. It should be noted that when a plurality of the deceleration end positions Pend exist, the assist control section 54 sets the deceleration end position Pend closest to the present own vehicle position P as the target deceleration end position Ptgt. In addition, the assist control section 54 sets the deceleration end vehicle speed Vend stored in the RAM or the back-up RAM of the assist control section 54 in association with the set deceleration end position Pend as a target deceleration end vehicle speed Vtgt.

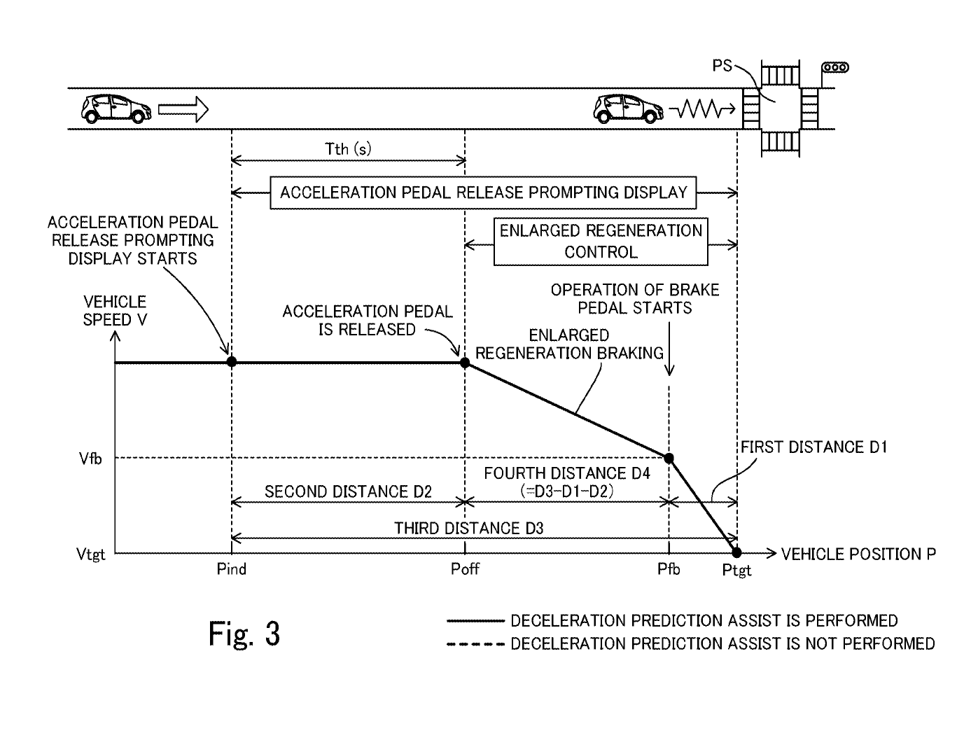

As shown in FIG. 3, the assist control section 54 calculates or acquires a position Pfb where a standard driver starts to operate the brake pedal 65 in order to achieve the target deceleration end vehicle speed Vtgt at the target deceleration end position Ptgt. In addition, the assist control section 54 calculates or acquires a traveling speed Vfb of the own vehicle when the own vehicle arrives at the position Pfb. Hereinafter, the position Pfb will be referred to as “the brake pedal operation start position Pfb” and the traveling speed Vfb will be referred to as “the brake pedal operation start vehicle speed Vfb”.

That is, when the target deceleration end vehicle speed Vtgt is determined, a distance D1 between the target deceleration end position Ptgt and the brake pedal operation start position Pfb and the brake pedal operation start vehicle speed Vfb are defined. Hereinafter, the distance D1 will be referred to as “the first distance D1”.

Accordingly, the assist control section 54 stores a relationship between the target deceleration end vehicle speed Vtgt and the first distance D1 and a relationship between the target deceleration end vehicle speed Vtgt and the brake pedal operation start vehicle speed Vfb in the ROM of the assist control section 54 in the form of a look-up table, respectively. The assist control section 54 applies the target deceleration end vehicle speed Vtgt to the look-up tables to calculate or acquire the first distance D1 and the brake pedal operation start vehicle speed Vfb, respectively. Further, the assist control section 54 calculates the brake pedal operation start position Pfb on the basis of the acquired first distance D1 and the target deceleration end position Ptgt.

In addition, the assist control section 54 calculates a distance D2 that the own vehicle travels at the present own vehicle speed V for a predetermined time Tth (in this embodiment, two seconds) and a distance D3 between the present own vehicle position P and the target deceleration end position Ptgt. Hereinafter, the predetermined time Tth will be referred to as “the threshold time Tth”, the distance D2 will be referred to as “the second distance D2” and the distance D3 will be referred to as “the third distance D3”.

The assist control section 54 calculates a distance D4 that the own vehicle is braked only by the regeneration braking torque by subtracting the first and second distances D1 and D2 from the third distance D3 (D4=D3−D1−D2). The distance D4 will be referred to as “the fourth distance D4”.

The assist control section 54 applies an average of the present own vehicle speed V of the own vehicle and the brake pedal operation start vehicle speed Vfb to a property line of a requested torque TQr used in the enlarged regeneration control shown by a chained line in the look-up table shown in FIG. 2 to calculate the requested torque TQr corresponding to an enlarged regeneration braking torque TQmbk (TQmbk<0) which is a regeneration braking torque (or an enlarged regeneration braking force or an increased regeneration braking force) upon the execution of the enlarged regeneration control. It should be noted that the look-up table MapTQr(AP,V) used in the normal acceleration/deceleration control is a table consisting of the property lines shown by solid lines in FIG. 2. The look-up table MapTQr(AP,V) used in the enlarged regeneration control corresponds to a table obtained by replacing the property line corresponding to Rap=0 and shown by the solid line in FIG. 2 with a property line shown by a chained line in FIG. 2.

The assist control section 54 calculates an estimated vehicle speed Vest which is the own vehicle speed V when the own vehicle has traveled the fourth distance D4 with the deceleration Gd generated by the enlarged regeneration braking torque TQmbk after the own vehicle has traveled the second distance D2 from the present own vehicle position P. The estimated vehicle speed Vest is smaller than the brake pedal operation start vehicle speed Vfb when a timing of starting an application of the regeneration braking torque is too early. That is, the estimated vehicle speed Vest is larger than the brake pedal operation start vehicle speed Vfb when the timing of starting the application of the regeneration braking torque is too late.

Accordingly, the assist control section 54 starts to cause the display device 81 to display a display (i.e., the acceleration pedal release prompting display) for prompting the driver of the own vehicle to release the acceleration pedal 35 when the estimated vehicle speed Vest becomes equal to or larger than the brake pedal operation start vehicle speed Vfb. In other words, the assist control section 54 performs an informing for prompting the driver to release the acceleration pedal 35. The display device 81 displays the acceleration pedal release prompting display in response to an acceleration pedal release signal output from the assist control section 54.

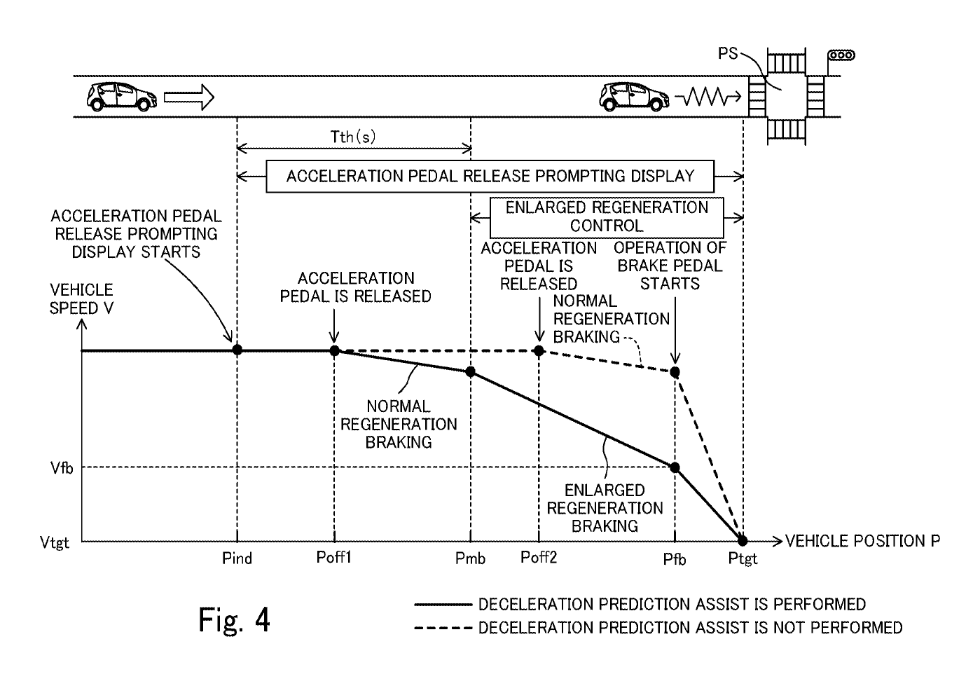

Next, the deceleration prediction assist control after the starting of the acceleration pedal release prompting display will be described with reference to FIG. 4. A change of the own vehicle speed V shown by a solid line in FIG. 4 is a change of the own vehicle speed V predicted in the case that the deceleration prediction assist control is executed and a change of the own vehicle speed V shown by a chained line in FIG. 4 is a change of the own vehicle speed V predicted in the case that the deceleration prediction assist control is not executed.

FIG. 4 shows a case that the acceleration pedal 35 is released at a position Poff1 before the threshold time Tth elapses after the acceleration pedal release prompting display is started. In this case, the PM control section 51 applies the present own vehicle speed V to the property line of the requested torque TQr used in the normal regeneration control shown by the solid line in the look-up table shown in FIG. 2 and corresponding to a case that the acceleration opening degree Rap (i.e., the acceleration pedal operation amount AP) is zero to calculate the requested torque TQr. In other words, the PM control section 51 calculates a regeneration braking torque TQmbn (<0) used in the normal regeneration control. Then, the PM control section 51 decelerates the own vehicle by the regeneration braking torque TQmbn until the threshold time Tth elapses. Hereinafter, the regeneration braking torque TQmbn used in the normal regeneration control will be referred to as “the normal regeneration braking torque TQmbn”.

Then, when the threshold time Tth elapses at a position Pmb, the assist control section 54 sends a command for causing the PM control section 51 to use the property line of the requested torque TQr used in the enlarged regeneration control shown by the chained line in the look-up table shown in FIG. 2 to the PM control section 51. As a result, when the acceleration pedal operation amount AP is zero, the PM control section 51 applies the present own vehicle speed V to the property line of the requested torque TQr used in the enlarged regeneration control each time a predetermined time elapses to calculate the requested torque TQr (i.e., the enlarged regeneration braking torque TQmbk). Then, the PM control section 51 decelerates the own vehicle by the enlarged regeneration braking torque TQmbk.

Then, when the driver of the own vehicle starts to operate the brake pedal 65 at the brake pedal operation start position Pfb, the PM control section 51 calculates the target friction braking torque TQfbtgt by adding the enlarged regeneration braking torque TQmbk to the requested braking torque TQbr acquired on the basis of the brake pedal operation amount BP (TQfbtgt=TQbr+TQmbk). Then, the PM control section 51 sends the calculated target friction braking torque TQfbtgt to the brake ECU 60.

When the own vehicle arrives at the target deceleration end position Ptgt, the assist control section 54 sends a command for causing the PM control section 51 to use the property line of the requested torque TQr used in the normal regeneration control shown by the solid line in the look-up table shown in FIG. 2 to the PM control section 51. As a result, the PM control section 51 controls the activation of the second MG 12 such that a half of the enlarged regeneration braking torque TQmbk is applied from the second MG 12 to the driving wheels 19, respectively until the own vehicle arrives at the target deceleration end position Ptgt. In addition, as described above, the brake ECU 60 controls the activation of the friction brake mechanism 40 such that one-quarter of the target friction braking torque TQfbtgt is applied to each of the four vehicle wheels including the driving wheels 19 by the friction brake mechanism 40.

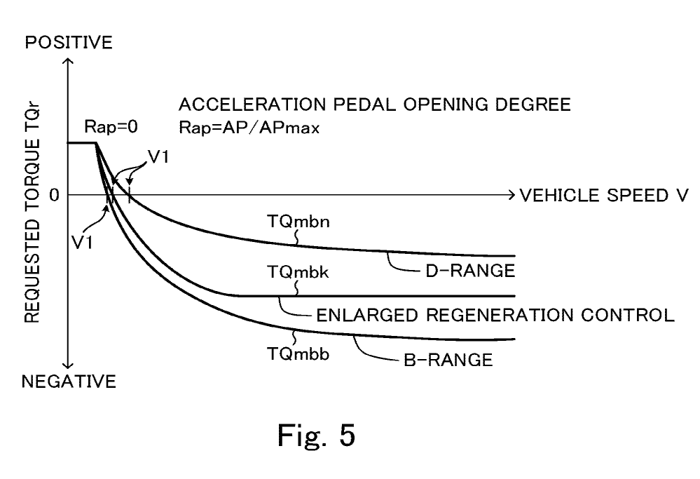

It should be noted that the enlarged regeneration control is executed when a shift lever of the own vehicle is set at a drive-range (i.e., a D-range). As shown in FIG. 5, the absolute value of the braking torque with the shift lever being set at the D-range and the enlarged regeneration control being executed, that is, the absolute value of the enlarged regeneration braking torque TQmbk, is larger than the absolute value of the braking torque with the enlarged regeneration control being not executed, that is, the absolute value of the normal regeneration braking torque TQmbn. Therefore, the amount of the electricity recovered to the battery 14 with the shift lever being set at the D-range and the enlarged regeneration control being executed, is larger than the amount of the electricity recovered to the battery 14 with the shift lever being set at the D-range and the enlarged regeneration control being not executed, that is, with the shift lever being set at the D-range and the normal acceleration/deceleration control being executed.

Further, as shown in FIG. 5, the absolute value of the enlarged regeneration braking torque TQmbk with the enlarged regeneration control being executed, is smaller than the absolute value of the regeneration braking torque TQmbb with the shift lever being set at a brake-range (i.e., a B-range). In addition, the absolute value of the enlarged regeneration braking torque TQmbk with the enlarged regeneration control being executed, is closer to the absolute value of the regeneration braking torque TQmbb with the shift lever being set at the B-range than the absolute value of the normal regeneration braking torque TQmbn with the shift lever being set at the D-range. As is known, when the acceleration pedal 35 is released, the braking torque provided from the engine 10 with the shift lever being set at the B-range is larger than the braking torque provided from the engine 10 with the shift lever being set at the D-range.

<Adjustment Between Downslope Prediction Control and Enlarged Regeneration Control>

Both a condition for executing the downslope prediction control and a condition for executing the enlarged regeneration control may be satisfied. In this case, the embodiment control apparatus executes the downslope prediction control in priority to the enlarged regeneration control and thus, forbids the execution of the enlarged regeneration control, that is, terminates the execution of the enlarged regeneration control or does not start the execution of the enlarged regeneration control in order to avoid unprofitable assist.

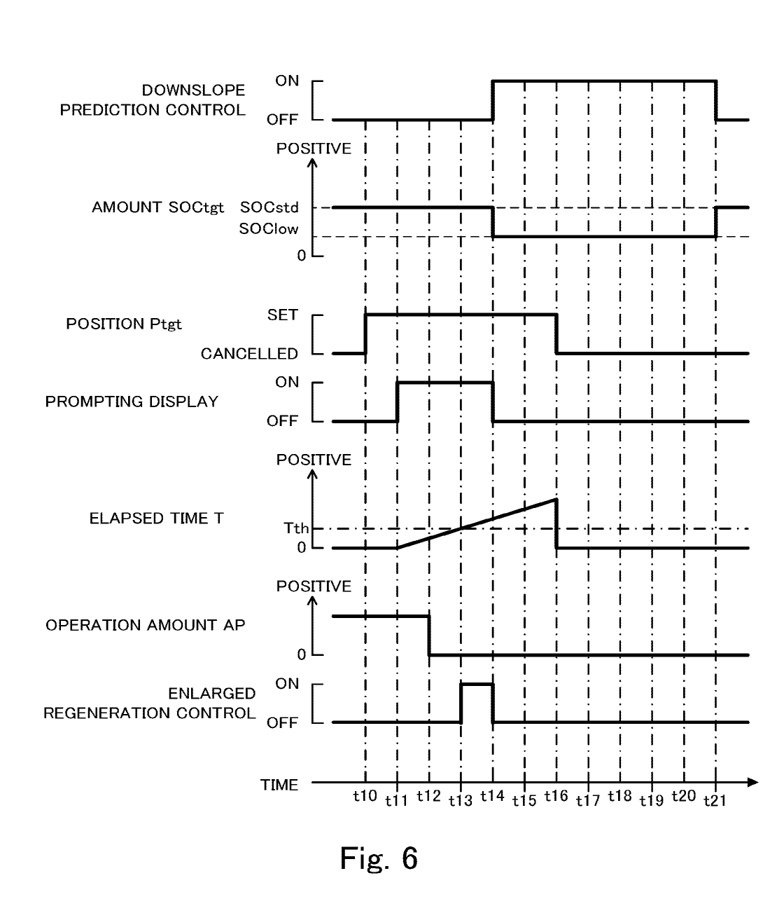

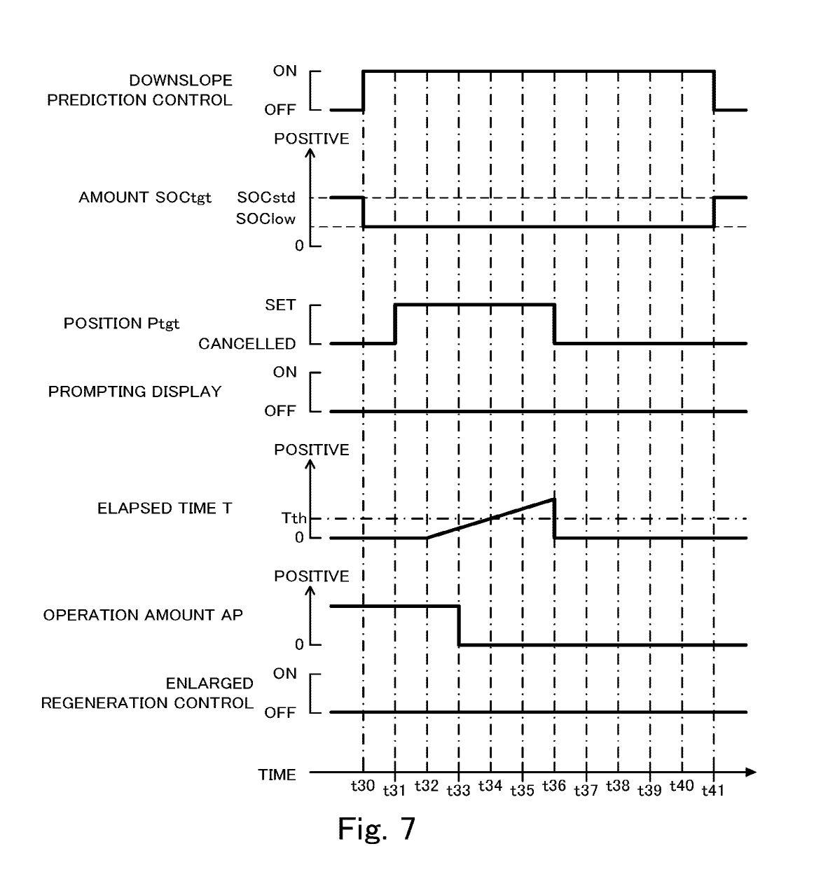

In particular, FIG. 6 is a time chart for showing the operation of the embodiment control apparatus when the condition for executing the downslope prediction control is satisfied during the execution of the enlarged regeneration control. FIG. 7 is a time chart for showing the operation of the embodiment control apparatus when the condition for executing the enlarged regeneration control during the execution of the downslope prediction control.

In an example shown in FIG. 6, at a time t10, the target deceleration end position Ptgt is set. Thereafter, at a time t11, the estimated vehicle speed Vest reaches the brake pedal operation start vehicle speed Vfb and thus, the acceleration pedal release prompting display is started. At this time, a measurement of a time T elapsing from the start of the acceleration pedal release prompting display is started. Hereinafter, the time T will be referred to as “the elapsed time T”.

Thereafter, at a time t12, the acceleration pedal 35 is released and thus, the acceleration pedal operation amount AP becomes zero.

At a time t13 after the time t12, the elapsed time T reaches the threshold time Tth. At this time, the downslope prediction control is not executed and thus, the embodiment control apparatus permits the execution of the enlarged regeneration control. Thereby, the execution of the enlarged regeneration control is started and thus, a half of the enlarged regeneration braking torque TQmbk is applied to the drive wheels 19, respectively.

Thereafter, at a time t14, the own vehicle arrives at the start position of the pre-downslope zone corresponding to the control execution downslope zone and thus, the execution of the downslope prediction control is started. In particular, the target charge amount SOCtgt is changed from the standard target value SOCstd to the low target value SOClow. At this time, the embodiment control apparatus forbids the execution of the enlarged regeneration control. In other words, at this time, both the condition for executing the downslope prediction control and the condition for executing the enlarged regeneration control are satisfied and thus, the embodiment control apparatus forbids the execution of the enlarged regeneration control. Therefore, at the time t14, the execution of the enlarged regeneration control and the acceleration pedal release prompting display are terminated.

At a time t16 after the time t14, the own vehicle passes the target deceleration end position Ptgt. As a result, the setting of the target deceleration end position Ptgt is cancelled. At this time, the measurement of the elapsed time T is terminated and the elapsed time T is cleared.

Thereafter, at a time t21, the own vehicle passes the end position of the control execution downslope zone and thus, the execution of the downslope prediction control is terminated. Thereby, the target charge amount SOCtgt is returned from the low target value SOClow to the standard target value SOCstd. It should be noted that when the execution of the downslope prediction control is terminated at the time t21, the embodiment control apparatus permits the execution of the enlarged regeneration control. In this example, although the execution of the enlarged regeneration control is permitted, the target deceleration end position Ptgt is not set and thus, the enlarged regeneration control is not executed.

On the other hand, in an example shown in FIG. 7, at a time t30, the execution of the downslope prediction control is started and thereby, the target charge amount SOCtgt is changed from the standard target value SOCstd to the low target value SOClow. Thereafter, at a time 31 during the execution of the downslope prediction control, the target deceleration end position Ptgt is set. Thereafter, at a time t32, the estimated vehicle speed Vest reaches the brake pedal operation start vehicle speed Vfb. At the time t32, the downslope prediction control is executed and thus, the embodiment control apparatus forbids the execution of the enlarged regeneration control. Therefore, the acceleration pedal release prompting display is not started. On the other hand, the measurement of the elapsed time T is started. Therefore, the elapsed time T represents a time elapsing from when the estimated vehicle speed Vest reaches the brake pedal operation start vehicle speed Vfb.

Thereafter, at a time t33, the acceleration pedal operation amount AP becomes zero. That is, the acceleration pedal 35 is released. Thereafter, at a time t34, the elapsed time T reaches the threshold time Tth. At this time, the downslope prediction control is executed and thus, the embodiment control apparatus continues to forbid the execution of the enlarged regeneration control. Therefore, the execution of the enlarged regeneration control is not started.

Thereafter, at a time t36, the own vehicle passes the target deceleration end position Ptgt and thus, the setting of the target deceleration end position Ptgt is cancelled. At this time, the measurement of the elapsed time T is terminated and the elapsed time T is cleared.

Thereafter, at a time t41, the own vehicle passes the end position of the control execution downslope zone and thus, the execution of the downslope prediction control is terminated. Thereby, the target charge amount SOCtgt is returned from the low target value SOClow to the standard target value SOCstd. Therefore, the embodiment control apparatus permits the execution of the enlarged regeneration control after the time t41. At this time, the target deceleration end position Ptgt is not set and thus, the enlarged regeneration control is not executed.

A summary of the operation of the embodiment control apparatus when both the condition for executing the downslope prediction control and the condition for executing the enlarged regeneration control, has been described. According to the embodiment control apparatus, when the downslope prediction control for decreasing the battery charge amount SOC is executed, the execution of the enlarged regeneration control for increasing the battery charge amount SOC is forbidden. Therefore, an unprofitable execution of the enlarged regeneration control during the execution of the downslope prediction control can be prevented.

<Concrete Operation of Embodiment Control Apparatus>

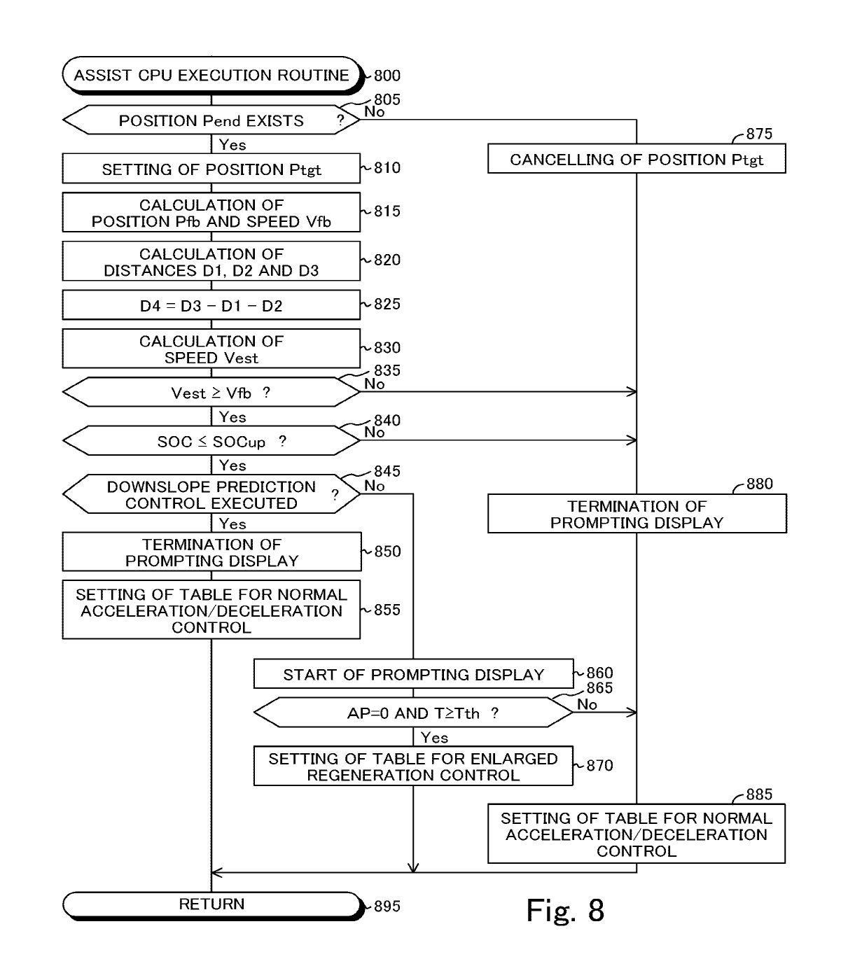

Next, a concrete operation of the embodiment control apparatus will be described. The CPU of the assist control section 54 is configured or programmed to execute a routine shown by a flowchart in FIG. 8 each time a predetermined time elapses. Hereinafter, the CPU of the assist control section 54 will be referred to as “the assist CPU”. At a predetermined timing, the assist CPU starts a process from a step 800 of FIG. 8 and then, proceeds with the process to a step 805 to determine whether or not the deceleration end position Pend exists on the scheduled vehicle traveling road within the predetermined distance from the present own vehicle position P.

When the deceleration end position Pend exists on the scheduled traveling road of the own vehicle within the predetermined distance from the present own vehicle position P, the assist CPU determines “Yes” at the step 805 and then, sequentially executes processes of steps 810 to 830. Then, the assist CPU proceeds with the process to a step 835.

Step 810: The assist CPU sets the deceleration end position Pend determined to exist at the step 805 as the target deceleration end position Ptgt.

Step 815: The assist CPU calculates the brake pedal operation start position Pfb and the brake pedal operation start vehicle speed Vfb on the basis of the present own vehicle position P and the present own vehicle speed V (see FIG. 3).

Step 820: The assist CPU calculates the first to third distances D1 to D3 on the basis of the brake pedal operation start position Pfb, the brake pedal operation start vehicle speed Vfb, the present own vehicle position P and the present own vehicle speed V (see FIG. 3).

Step 825: The assist CPU calculates the fourth distance D4 on the basis of the first to third distances D1 to D3 (D4=D3−D1−D2) (see FIG. 3).

Step 830: The assist CPU calculates the estimated vehicle speed Vest on the basis of the brake pedal operation start position Pfb, the present own vehicle speed V, the second distance D2, the fourth distance D4 and the deceleration Gd of the own vehicle with a half of the enlarged regeneration braking torque TQmbk being applied to each of the driving wheels 19.

When the assist CPU proceeds with the process to the step 835, the assist CPU determines whether or not the estimated vehicle speed Vest is equal to or larger than the brake pedal operation start vehicle speed Vfb. That is, the assist CPU determines whether or not the own vehicle speed V reaches the brake pedal operation start vehicle speed Vfb when the own vehicle arrives at the brake pedal operation start position Pfb assuming that the acceleration pedal release prompting display is started at the present time and then, the acceleration pedal 35 is released upon the elapsing of the threshold time Tth from the start of the acceleration pedal release prompting display.

When the estimated vehicle speed Vest is equal to or larger than the brake pedal operation start vehicle speed Vfb, the assist CPU determines “Yes” at the step 835 and then, proceeds with the process to a step 840 to determine whether or not the present battery charge amount SOC is equal to or smaller than an upper limit charge amount SOCup. The upper limit charge amount SOCup is set to an upper limit value of the battery charge amount SOC capable of preventing a deterioration of the battery 14.

When the present battery charge amount SOC is equal to or smaller than the upper limit charge amount SOCup, the assist CPU determines “Yes” at the step 840 and then, proceeds with the process to a step 845 to determine whether or not the downslope prediction control is executed. In particular, the assist CPU determines whether or not the target charge amount SOCtgt is set to the low target value SOClow. It should be noted that when the assist CPU determines “Yes” at the steps 805, 835 and 840, respectively, the condition for executing the enlarged regeneration control is satisfied.

When the downslope prediction control is executed, the assist CPU determines “Yes” at the step 845 and then, sequentially executes processes of the steps 850 and 855 described below. Then, the assist CPU proceeds with the process to a step 895 to terminate the execution of this routine once.

Step 850: The assist CPU causes the acceleration pedal release prompting display to be terminated if the acceleration pedal release prompting display is performed. On the other hand, the assist CPU forbids the performance of the acceleration pedal release prompting display if the acceleration pedal release prompting display is not performed.

Step 855: The assist CPU provides the CPU of the PM control section 51 with a command for causing the PM control section 51 to set the look-up table MapTQr(AP,V) for the normal acceleration/deceleration control as the look-up table used for acquiring the requested torque TQr. Hereinafter, the CPU of the PM control section 51 will be referred to as “PM CPU” and the look-up table for acquiring the requested torque TQr will be referred to as “the torque acquisition table”. As a result, even when the condition for executing the enlarged regeneration control is satisfied, the acceleration pedal release prompting display is not performed and the look-up table for the normal acceleration/deceleration control is set as the torque acquisition table MapTQr(AP,V). Thereby, the execution of the enlarged regeneration control including the acceleration pedal release prompting display is forbidden during the execution of the downslope prediction control.

On the other hand, when the downslope prediction control is not executed upon the execution of the process of the step 845, the assist CPU determines “No” at the step 845 and then, proceeds with the process to a step 860 to start the acceleration pedal release prompting display. Then, the assist CPU proceeds with the process to a step 865. It should be noted that when the acceleration pedal release prompting display has been already performed, the assist CPU confirms that the acceleration pedal release prompting display is performed at the step 860.

When the assist CPU proceeds with the process to the step 865, the assist CPU determines whether or not the present acceleration pedal operation amount AP is zero and the elapsed time T is equal to or larger than the threshold time Tth. As described above, the elapsed time T corresponds to a time elapsing from the start of the performance of the acceleration pedal release prompting display.

When the acceleration pedal operation amount AP is zero and the elapsed time T is equal to or larger than the threshold time Tth, the assist CPU determines “Yes” at the step 865. Then, the assist CPU proceeds with the process to a step 870 to provide the PM CPU with a command for causing the PM CPU to set the look-up table MapTQr(AP,V) for the enlarged regeneration control as the torque acquisition table. Then, the assist CPU proceeds with the process to the step 895 to terminate the execution of this routine once.

On the other hand, when the acceleration pedal operation amount AP is larger than zero or the elapsed time T is smaller than the threshold time Tth upon the execution of the process of the step 865, the assist CPU determines “No” at the step 865 and then, proceeds with the process to a step 885 to provide the PM CPU with a command for causing the PM CPU to set the look-up table MapTQr(AP,V) for the normal acceleration/deceleration control as the torque acquisition table. Then, the assist CPU proceeds with the process to the step 895 to terminate the execution of this routine once.

It should be noted that when the deceleration end position Pend does not exist upon the execution of the process of the step 805, the assist CPU determines “No” at the step 805 and then, proceeds with the process to a step 875 to cancel the target deceleration end position Ptgt when the target deceleration end position Ptgt is set. Then, the assist CPU proceeds with the process to a step 880.

Further, when the estimated vehicle speed Vest is smaller than the brake pedal operation start vehicle speed Vfb upon the execution of the process of the step 835, the assist CPU determines “No” at the step 835 and then, proceeds with the process to the step 880.

In addition, when the present battery charge amount SOC is larger than the upper limit charge amount SOCup upon the execution of the process of the step 840, the assist CPU determines “No” at the step 840 and then, proceeds with the process to the step 880.

When the assist CPU proceeds with the process to the step 880 and the acceleration pedal release prompting display is performed, the assist CPU terminates the acceleration pedal release prompting display. On the other hand, when the assist CPU proceeds with the process to the step 880 and the acceleration pedal release prompting display is not performed, the assist CPU forbids the performance of the acceleration pedal release prompting display. Next, the assist CPU proceeds with the process to the step 885 to send the command for causing the PM CPU to set the normal acceleration/deceleration control look-up table MapTQr(AP,V) as the torque acquisition table. Then, the assist CPU proceeds with the process to the step 895 to terminate the execution of this routine once.

The PM CPU is configured or programmed to execute a routine shown by a flowchart in FIG. 9 each time a predetermined time elapses. Therefore, at a predetermined timing, the PM CPU starts a process from a step 900 of FIG. 9 and then, proceeds with the process to a step 905 to acquire the present own vehicle speed V and the present acceleration pedal amount AP.

Next, the PM CPU proceeds with the process to a step 910, the PM CPU determines whether or not the acceleration pedal operation amount AP is larger than zero. When the acceleration pedal operation amount AP is larger than zero, the PM CPU determines “Yes” at the step 910 and then, sequentially executes processes of steps 915 to 945 described below. Then, the PM CPU proceeds with the process to a step 995 to terminate an execution of this routine once.

Step 915: The PM CPU acquires the present battery charge amount SOC and the present second MG rotation speed NM2.

Step 920: The PM CPU applies the acceleration pedal operation amount AP and the own vehicle speed V to the torque acquisition table MapTQr(AP,V) presently set in accordance with the command sent from the assist CPU to acquire the requested torque TQr. It should be noted that the PM CPU is configured or programmed to set the look-up table for the normal acceleration/deceleration control as the torque acquisition table MapTQr(AP,V) in an initialization routine executed when a position of the ignition switch or a power switch (not shown) of the own vehicle is changed from the ON-position to an OFF-position.

Step 925: The PM CPU calculates the aforementioned requested drive output Pr* by multiplying the requested torque TQr by the second MG rotation speed NM2 (Pr*=TQr·NM2).

Step 927: The PM CPU calculates the charge amount difference dSOC by subtracting the present battery charge amount SOC from the presently-set target charge amount SOCtgt (dSOC=SOCtgt−SOC). It should be noted that the assist CPU is configured or programmed to set the target charge amount SOCtgt to the standard target value SOCstd in the aforementioned initialization routine.

Step 930: The PM CPU applies the charge amount difference dSOC to a look-up table MapPb*(dSOC) shown in the block B to acquire the requested charge output power Pb*.

Step 935: The PM CPU calculates a sum of the requested driving output power Pr* and the requested charge output power Pb* as the requested engine output power Pe* (Pe*=Pr*+Pb*).

Step 940: The PM CPU acquires the target engine torque TQetgt, the target engine speed NEtgt, the target first MG torque TQ1tgt, the target first MG rotation speed NM1tgt, the target second MG torque TQ2tgt and the like on the basis of the second MG rotation speed NM2 and the requested engine output power Pe* as described above.

Step 945: The PM CPU executes a process for operating the engine 10 and activating the first and second MGs 11 and 12 such that the values acquired at the step 940 are achieved. That is, the PM CPU sends commands to the engine control section 52 and the MG control section 53.

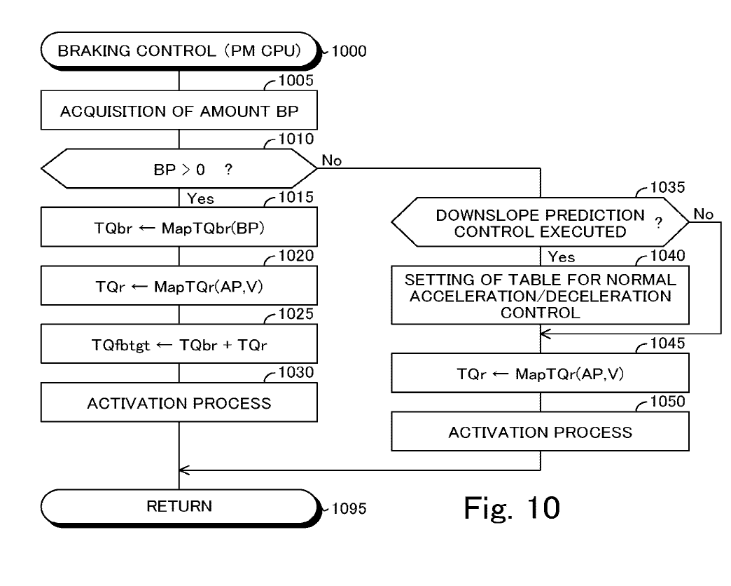

When the acceleration pedal operation amount AP is zero upon the execution of the process of the step 910, the PM CPU determines “No” at the step 910 and then, proceeds with the process to a step 950 to execute a routine show by a flowchart in FIG. 10 to execute a braking control for applying braking torque to the drive wheels 19 or the vehicle wheels including the drive wheels 19.

Therefore, when the PM CPU proceeds with the process to the step 950, the PM CPU starts a process from a step 1000 of FIG. 10 and then, proceeds with the process to a step 1005 to acquire the present brake pedal operation amount BP from the brake ECU 60.

Next, the PM CPU proceeds with the process to a step 1010 to determine whether or not the brake pedal operation amount BP is larger than zero. When the brake pedal operation amount BP is larger than zero, the PM CPU determines “Yes” at the step 1010 and then, sequentially executes processes of steps 1015 to 1030 described below. Then, the PM CPU proceeds with the process to the step 995 of FIG. 9 via a step 1095.

Step 1015: The PM CPU applies the brake pedal operation amount BP to a look-up table MapTQbr(BP) to acquire the aforementioned requested braking torque TQbr. According to the table MapTQbr(BP), the absolute value of the requested braking torque TQbr increases as the brake pedal operation amount BP increases.

Step 1020: The PM CPU applies the acceleration pedal operation amount AP acquired at the step 905 of FIG. 9 (in this case, the acceleration pedal operation amount AP is zero) and the own vehicle speed V acquired at the step 905 of FIG. 9 to the presently-set torque acquisition table MapTQr(AP,V) to acquire the requested torque TQr. When the own vehicle speed V is larger than the switching vehicle speed V1, the acquired requested torque TQr is a negative value (i.e., the braking torque). On the other hand, when the own vehicle speed V is equal to or smaller than the switching vehicle speed V1, the acquired requested torque TQr is a positive value (i.e., the driving torque).

In particular, when the look-up table to be used in the enlarged regeneration control is set as the torque acquisition table MapTQr(AP,V), the acquired requested torque TQr is the enlarged regeneration braking torque TQmbk with the own vehicle speed V being larger than the switching vehicle speed V1 and the acquired requested torque TQr is the driving torque TQmdk with the own vehicle speed V being equal to or smaller than the switching vehicle speed V1.

On the other hand, when the look-up table to be used in the normal acceleration/deceleration control is set as the torque acquisition table MapTQr(AP,V), the acquired requested torque TQr is the normal regeneration braking torque TQmbn with the own vehicle speed V being larger than the switching vehicle speed V1 and the acquired requested torque TQr is the driving torque TQmdn with the own vehicle speed V being equal to or smaller than the switching vehicle speed V1.

Step 1025: The PM CPU calculates the target friction braking torque TQfbtgt by adding the requested torque TQr to the requested braking torque TQbr (TQfbtgt=TQbr+TQr).

Step 1030: The PM CPU executes a process for activating the second MG 12 (i.e., a process for sending a command to the MG control section 53) such that the requested torque TQr is applied from the second MG 12 to the driving wheels 19. Further, the PM CPU sends the target friction braking torque TQfbtgt to the brake ECU 60. As a result, a half of the requested torque TQr (the driving torque or the braking torque) is applied from the second MG 12 to the driving wheels 19, respectively and one-fourth of the target friction braking torque TQfbtgt is applied to each of the vehicle wheels including the driving wheels 19 by the friction brake mechanism 40.

On the other hand, when the brake pedal operation amount BP is zero upon the execution of the process of the step 1010, the PM CPU determines “No” at the step 1010 and then, proceeds with the process to a step 1035 to determine whether or not the downslope prediction control is executed. In particular, the PM CPU determines whether or not the target charge amount SOCtgt is set to the low target value SOClow.

When the downslope prediction control is executed, the PM CPU determines “Yes” at the step 1035 and then, proceeds with the process to a step 1040 to set the look-up table for the normal acceleration/deceleration control as the torque acquisition table MapTQr(AP, V). Then, the PM CPU proceeds with the process to a step 1045. In this case, the PM CPU sets the look-up table for the normal acceleration/deceleration control as the torque acquisition table MapTQr(AP, V) even when the assist CPU executes the process of the step 870 to send a command to the PM CPU in order to cause the PM CPU to set the look-up table MapTQr(AP, V) for the enlarged regeneration control as the torque acquisition table. Thereby, the execution of the enlarged regeneration control is forbidden during the execution of the downslope prediction control.

When the downslope prediction control is not executed upon the execution of the process of the step 1035, the PM CPU determines “No” at the step 1035 and then, proceeds with the process directly to the step 1045.

When the PM CPU proceeds with the process to the step 1045, the PM CPU acquires the requested torque TQr similar to the process of the step 1020.

Next, the PM CPU proceeds with the process to a step 1050 to execute a process for activating the second MG 12 (i.e., sending a command to the MG control section 53 to activate the second MG 12) such that the requested torque TQr acquired at the step 1045 is applied from the second MG 12 to the drive wheels 19. In addition, the PM CPU sends information that the target friction braking torque TQfbtgt is zero to the brake ECU 60. As a result, no friction braking force is generated by the friction brake mechanism 40.

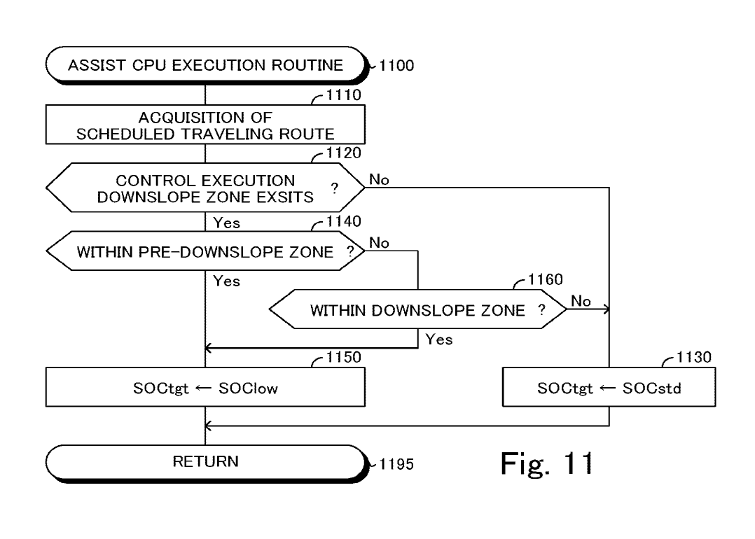

Further, the assist CPU is configured or programmed to execute a routine shown by a flowchart in FIG. 11 each time a predetermine time elapses. At a predetermined timing, the assist CPU starts a process from a step 1100 of FIG. 11 and then, proceeds with the process to a step 1110 to acquire the scheduled traveling route from the navigation device 80.

Next, the assist CPU proceeds with the process to a step 1120 to determine whether or not the control execution downslope zone exists along the scheduled traveling route. As described above, the control execution downslope zone is the downslope zone which satisfies the aforementioned downslope zone condition. When the control execution downslope zone does not exist along the scheduled traveling route, the assist CPU determines “No” at the step 1120 and then, proceeds with the process to a step 1130 to set the standard target value SOCstd as the target charge amount SOCtgt. Then, the assist CPU proceeds with the process to a step 1195 to terminate an execution of this routine once.

On the other hand, when the control execution downslope zone exists along the scheduled traveling route, the assist CPU determines “Yes” at the step 1120 and then, proceeds with the process to a step 1140 to determine whether or not the present own vehicle position P is within the pre-downslope zone corresponding to the control execution downslope zone. In this regard, when a plurality of the control execution downslope zones exist, the assist CPU determines whether or not the present own vehicle position P is within the pre-downslope zone corresponding to the control execution downslope zone closest to the own vehicle.

When the own vehicle position P is within the pre-downslope zone, the assist CPU determines “Yes” at the step 1140 and then, proceeds with the process to a step 1150 to set the low target value SOClow as the target charge amount SOCtgt. Then, the assist CPU proceeds with the process to the step 1195 to terminate the execution of this routine once. Thereby, the execution of the downslope prediction control is started when the own vehicle arrives at the start position of the pre-downslope zone.

On the other hand, when the own vehicle position P is not within the pre-downslope zone, the assist CPU determines “No” at the step 1140 and then, proceeds with the process to a step 1160 to determine whether or not the present own vehicle position P is within the control execution downslope zone. When the present own vehicle position P is within the control execution downslope zone, the assist CPU determines “Yes” at the step 1160 and then, proceeds with the process to the step 1150.

On the other hand, when the present own vehicle position P is not within the control execution downslope zone, the assist CPU determines “No” at the step 1060 and then, proceeds with the process to the step 1130. As a result, when the own vehicle arrives at the end position of the control execution downslope zone, the target charge amount SOCtgt is returned to the standard target value SOCstd and thus, the execution of the downslope prediction control is terminated.

The concrete operation of the embodiment control apparatus has been described. According to the embodiment control apparatus, when both the condition for executing the downslope prediction control and the condition for executing the enlarged regeneration control are satisfied, the execution of the enlarged regeneration control is forbidden and thus, the unprofitable execution of the enlarged regeneration control, i.e., the unprofitable assist can be prevented.

### Modified Example

Next, the vehicle control apparatus according to a modified example of the embodiment will be described. The vehicle control apparatus according to the modified example (hereinafter, will be referred to as “the modified control apparatus”) employs the condition that the downslope prediction control is not executed as well as a condition that a battery/MG condition described later is satisfied as the condition for permitting the execution of the enlarged regeneration control.

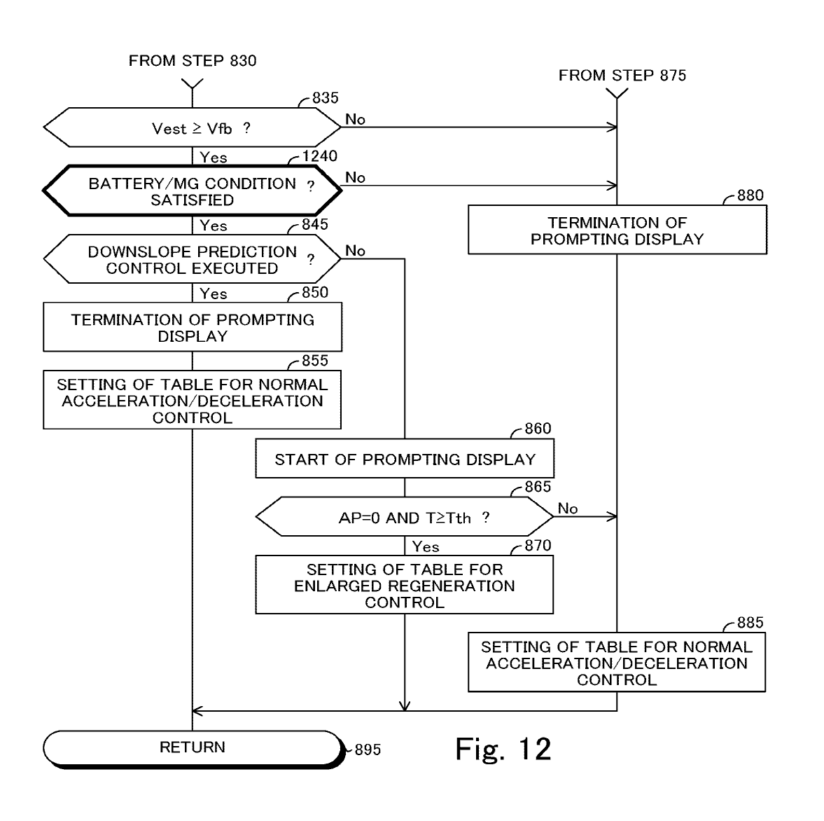

In particular, the assist CPU of the modified control apparatus is configured or programmed to execute a process of a step 1240 shown in FIG. 12 in place of the step 840 of FIG. 8. In this case, when the assist CPU determines “Yes” at the step 835, the assist CPU proceeds with the process to the step 1240 to determine whether or not the battery/MG condition is satisfied.

The battery/MG condition is satisfied when all following conditions A to D are satisfied.

Condition A: A battery charge rate BCR is equal to or smaller than a threshold charge rate BCRth.

Condition B: A temperature TB of the battery 14 is within a predetermined temperature range TR.

Condition C: The regeneration electricity amount REA is equal to or smaller than a threshold regeneration electricity amount REAth.

Condition D: A load rate LR of the second MG 12 is equal to or smaller than a threshold load rate LRth.

Below, the conditions A to D will be described, respectively.

Condition A: The battery charge rate BCR is equal to or smaller than the threshold charge rate BCRth.

The battery charge rate BCR is a rate of the battery charge amount SOC with respect to a maximum amount SOCmax which is the battery charge amount SOC that the battery 14 can charge to the maximum extent (BCR=SOC/SOCmax·100(%). The threshold charge rate BCRth is set to an upper limit value of the battery charge rate BCR which does not deteriorate the battery 14 when the regeneration electricity generated by the regeneration braking is supplied to the battery 14.

Condition B: The temperature TB of the battery 14 is within the predetermined temperature range TR.

The predetermined temperature range TR is set to a range of the temperature TB of the battery 14 which does not deteriorate the battery 14 when the regeneration electricity is supplied to the battery 14.

Condition C: The regeneration electricity amount REA is equal to or smaller than the threshold regeneration electricity amount REAth.

The regeneration electricity amount REA is an amount of the electricity per unit time which is supplied from the second MG 12 to the battery 14 when the normal regeneration control or the enlarged regeneration control is executed and calculated in accordance with a following equation (1).

REA=(V·Gd·W)/1000 (1)

REA is the regeneration electricity amount (kW).

V is the own vehicle speed (m/s).

Gd is the deceleration (m/s²) of the own vehicle.

W is a weight (kg) of the own vehicle.

The threshold regeneration electricity amount REAth is set to an upper limit value of the regeneration electricity amount REA which does not deteriorate the battery 14.

Condition D: The load rate LR of the second MG 12 is equal to or smaller than the threshold load rate LRth.

The load rate LR of the second MG 12 is a ratio of the actual amount of the regeneration electricity generated by the second MG 12 with respect to a maximum value of the regeneration electricity allowed to be generated by the second MG 12.

When the battery/MG condition is satisfied upon the execution of the process of the step 1240, the assist CPU determines “Yes” at the step 1240 and then, proceeds with the process to the step 845. On the other hand, when the battery/MG condition is not satisfied, the assist CPU determines “No” at the step 1240 and then, proceeds with the process to the step 880.

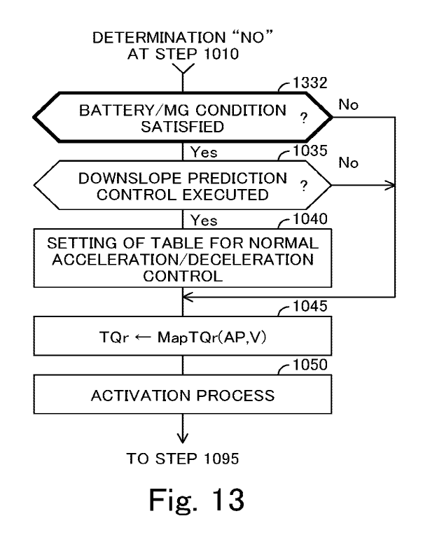

Further, as shown in FIG. 13, when the PM CPU determines “No” at the step 1010 of FIG. 10, the PM CPU of the modified control apparatus is configured or programmed to execute a process of a step 1332 of FIG. 13 before the PM CPU proceeds with the process to the step 1035. That is, when the PM CPU determines “No” at the step 1010, the PM CPU proceeds with the process to the step 1332 to determine whether or not the battery/MG condition is satisfied.

When the battery/MG condition is satisfied, the PM CPU determines “Yes” at the step 1332 and then, proceeds with the process to the step 1035. On the other hand, when the battery/MG condition is not satisfied, the PM CPU determines “No” at the step 1332 and then, proceeds with the process directly to the step 1045.

According to the modified control apparatus, only when the battery 14 and the second MG 12 are not deteriorated by the electricity generated by the enlarged regeneration control (see the determination “Yes” at the step 1332), the enlarged regeneration control is executed. Thus, the electricity generated by the enlarged regeneration control can be recovered to the battery 14 without deteriorating the battery 14 and the second MG 12.

The present invention is not limited to the embodiment nor the modified example and various modifications can be employed within a scope of the present invention. For example, the embodiment control apparatus may be configured to apply the torque, which corresponds to the torque applied to the drive wheels 19 by the enlarged regeneration control, from the engine 10 to the drive wheels 19 while the embodiment control apparatus has set the target deceleration end position Ptgt after the embodiment control apparatus starts to execute the downslope prediction control during the execution of the enlarged regeneration control and then, terminates the execution of the enlarged regeneration control.

Further, the embodiment control apparatus terminates the acceleration pedal release prompting display when the embodiment control apparatus forbids the execution of the enlarged regeneration control. In this regard, the embodiment control apparatus may be configured to continue the acceleration pedal release prompting display after the embodiment control apparatus forbids the execution of the enlarged regeneration control. In this case, when the acceleration pedal 35 is released, the embodiment control apparatus forbids an application of the enlarged regeneration braking torque determined using the property line of the requested torque TQr for the enlarged regeneration control and performs the regeneration braking by using the property line of the requested torque TQr for the normal regeneration control.

Further, the embodiment control apparatus may be configured to execute the enlarged regeneration control when the target deceleration end position Ptgt is set, the acceleration pedal operation amount AP is zero and the elapsed time T is equal to or larger than the threshold time Tth upon the termination of the execution of the downslope prediction control, that is, when the condition for executing the enlarged regeneration control has been satisfied upon the termination of the execution of the downslope prediction control.

Further, in the embodiment, the process of the step 840 of FIG. 8 may be omitted. In this case, when the estimated vehicle speed Vest is equal to or larger than the brake pedal operation start vehicle speed Vfb upon the execution of the process of the step 835, the assist CPU determines “Yes” at the step 835 and then, proceeds with the process directly to the step 845.

Further, in the deceleration prediction assist control according to the embodiment, the assist control section 54 may be configured to acquire the difference between the own vehicle speed V and the traveling speed of the preceding vehicle (i.e., the relative vehicle speed), the distance between the own vehicle and the preceding vehicle (i.e., the inter-vehicle distance) and the like on the basis of the information received from the own vehicle sensor 83. Then, when the assist control section 54 determines that the preceding vehicle stops on the basis of the acquired relative vehicle speed, the acquired inter-vehicle distance, the own vehicle speed and the like, the assist control section 54 may be configured to calculate a position where the own vehicle should be stopped as the deceleration end position Pend and store the deceleration end position Pend in the RAM of the assist control section 54. In this case, the assist control section 54 stores the own vehicle speed V upon the arrival of the own vehicle at the deceleration end position Pend (in this case, the own vehicle speed V is zero) as the deceleration end vehicle speed Vend in the RAM of the assist control section 54 in association with the deceleration end position Pend.

In addition, the own vehicle, to which the embodiment control apparatus is applied, may be a vehicle having one of the first MG 11 and the second MG 12.

What is claimed is:

1. A vehicle control apparatus applied to a hybrid vehicle having:
a vehicle driving source including an internal combustion engine and an electric motor; and
a battery charged with electricity generated by the electric motor, the battery supplying the electricity to the electric motor,
the vehicle control apparatus comprising a control section configured to control an operation of the internal combustion engine and an activation of the electric motor,
wherein the control section further comprises:
normal regeneration control means configured to execute a normal regeneration control for applying a regeneration braking force to at least one vehicle wheel of the hybrid vehicle by using the electric motor and charging the battery with the electricity generated by the electric motor when an acceleration operation amount which is an amount of an operation of an acceleration operator is zero;
enlarged regeneration control means configured to execute an enlarged regeneration control for applying an increased regeneration braking force which is the regeneration braking force larger than the regeneration braking force applied by the normal regeneration control to the at least one vehicle wheel and charging the battery with the electricity generated by the electric motor when a position where it is predicted that a deceleration of the hybrid vehicle ends is set as a target deceleration end position where the deceleration of the hybrid vehicle ends and the acceleration operation amount is zero;
downslope prediction control means configured to execute a downslope prediction control for controlling the activation of the electric motor and the operation of the internal combustion engine when the downslope prediction control means determines that a control execution downslope zone which satisfies a predetermined downslope zone condition exists on a scheduled traveling route of the hybrid vehicle such that a first battery charge amount becomes smaller than a second battery charge amount, the first battery charge amount being an amount of the electricity charged in the battery upon arrival of the hybrid vehicle at a start position of the control execution downslope zone when it is determined that the control execution downslope zone exists on the scheduled traveling route, the second battery charge amount being the amount of the electricity charged in the battery upon the arrival of the hybrid vehicle a position corresponding to the start position of the control execution downslope zone when it is not determined that the control execution downslope zone exists on the scheduled traveling route; and
enlarged regeneration forbiddance means configured to forbid an execution of the enlarged regeneration control when both a condition for executing the downslope prediction control and a condition for executing the enlarged regeneration control are satisfied.

2. The vehicle control apparatus according to claim 1, characterized in that the enlarged regeneration control means is configured to execute the enlarged regeneration control:
to perform an informing for prompting a driver of the hybrid vehicle to release the acceleration operator when the hybrid vehicle arrives at a predetermined first position before the target deceleration end position with the target deceleration end position being set; and
to apply the increased regeneration braking force to the at least one vehicle wheel after the hybrid vehicle arrives at a predetermined second position between the predetermined first position and the target deceleration end position.
